(19) United States
(12) Patent Application Publication
(10) Pub. No.: US 2021/0385287 A1
(43) Pub. Date: Dec. 9, 2021

(54) COMPUTING SERVICE MANAGEMENT APPARATUS, METHOD, AND STORAGE MEDIUM

(71) Applicant: Hitachi, Ltd., Tokyo (JP)

(72) Inventors: Rong ZHANG, Tokyo (JP); Kiminori SUGAUCHI, Tokyo (JP); Yasuto NISHII, Tokyo (JP)

(73) Assignee: Hitachi, Ltd.

(21) Appl. No.: 17/169,129

(22) Filed: Feb. 5, 2021

(30) Foreign Application Priority Data
Jun. 9, 2020 (JP) 2020-100425

(51) Int. Cl. H04L 29/08; H04L 12/911; H04L 12/721

(52) U.S. Cl. CPC H04L 67/16; H04L 47/82; G06F 9/44; H04L 67/10; H04L 45/12

(57) ABSTRACT

A management apparatus includes: a service information acquisition unit that acquires resource information indicating an available resource of a computer, and acquires service information including a target sensor that acquires data to be used by a target service, a required resource for the target service, and a target controller that executes control by the target service; and an arrangement measurement unit that set a computer that covers the required resource by the available resource as a candidate computer, calculates, for a candidate course, which is a combination of an input course from the target sensor to the candidate computer and an output course from the candidate computer to the target controller, a total cost for causing data to be used by the target service to flow, by considering a path through which the data to be used by the target service is caused to flow by a co-existing service.

### BACKGROUND

This disclosure relates to a technology of managing a computing service.

In recent years, the type and number of sensors that are coupled to a network, and acquire and transmit data have been increasing in an IoT (Internet of Things) system, and the amount of collected and accumulated data has also been increasing. There are various types of sensors, and examples thereof include a sensor that measures a humidity or a temperature, a camera that acquires image data or video data, and a smartphone and a tablet terminal held by many people. When control by IoT is implemented by cloud computing, a sensor that acquires data and a controller that executes control are communicably coupled to a cloud. Then, the data acquired by the sensor is analyzed through calculation on the cloud, and a result of the analysis is reflected in control by the controller. In that case, it is necessary to transfer the data acquired by the sensor to the cloud via a network. Furthermore, it is also necessary to transfer the result of calculation on the cloud to the controller via the network. When the amount of data flowing through the network becomes enormous, delay or congestion is more likely to occur in the network, and the real time property or reliability of control may be impaired. Furthermore, the network cost or communication cost may increase due to transfer of a large amount of data. In particular, the amount of data of a video or a sound is extremely large, which has a large influence.

Edge computing receives attention against this background. In edge computing, a gateway apparatus (hereinafter also referred to as “edge device”) having an intelligent function capable of executing calculation is arranged at a position near a sensor, and the edge device executes processing of analyzing data, which has originally been executed on the cloud. As a result, in edge computing, the real time property or reliability of control is expected to increase compared to cloud computing. Furthermore, edge computing is also considered to contribute to reduction of the network cost or communication cost. In order to achieve improvement in real time property and reliability and reduction of the cost by an edge computing system, it is required to appropriately determine which edge device at which position on the network is to execute the processing of analyzing data.

Japanese Patent Application Publication No. 2017-143365 discloses a technology for deploying an application of a service provider at an optimal location in a network environment that arranges data centers in a carrier network in a distributed manner. The technology of Japanese Patent Application Publication No. 2017-143365 determines an optimal arrangement of applications that minimizes a delay time based on allowable delay time information, used bandwidth information, a bandwidth length, and path length information of each path in each section.

### SUMMARY

In the IoT system, a plurality of computing systems may use data acquired by the same sensor. For example, another computing system that uses the same data as data used by a computing system that has already provided a service may be newly constructed. However, the technology of Japanese Patent Application Publication No. 2017-143365 does not consider a case in which a plurality of computing systems use data acquired by the same sensor. Thus, this technology cannot necessarily be said to effectively reduce data flowing through the network. The same data acquired by the same sensor may flow through the network in a duplicate manner, which may increase the amount of data on the network.

An object of this disclosure is to provide a technology of supporting implementation of suitable computing that uses a network efficiently.

A computing service management apparatus according to one embodiment mode of this disclosure is a computing service management apparatus configured to support deployment of a service, the service executing control by a controller based on the data acquired by a sensor, in a computing system including computers each having a resource available for processing of analyzing data acquired from a sensor and generating an instruction signal instructing the controller to execute control in the service, the computing service management apparatus including: a resource information collection unit configured to acquire resource information indicating an available resource that is available among resources included in the computers; a service information acquisition unit configured to acquire, for a target service to be deployed in the computing system, service information including a target sensor configured to acquire data to be used by the target service, a required resource required for the target service, and a target controller configured to execute control by the target service; and

an arrangement measurement unit configured to acquire data transfer information indicating a course through which data of a co-existing service co-existing with the target service in the computing system flows, set a computer that covers the required resource by the available resource as a candidate computer, extract a candidate course which is a combination of an input course from the target sensor to the candidate computer and an output course from the candidate computer to the target controller, and calculate, for the candidate course and at least the input course, a total cost for causing data to be used by the target service to flow, by considering using data caused to flow by the co-existing service for the target service for a path through which the data to be used by the target service is caused to flow by the co-existing service.

According to one mode of this disclosure, it is possible to support implementation of suitable computing that uses a network efficiently.

### BRIEF DESCRIPTION OF THE DRAWINGS

FIG. 1 is a diagram illustrating an exemplary configuration of a computing system according to a first embodiment;

FIG. 2 is a diagram illustrating an exemplary configuration of a management sever according to the first embodiment;

FIG. 3 is a diagram illustrating an exemplary configuration of an input UI;

FIG. 4 is a diagram illustrating an exemplary configuration of an output UI;

FIG. 5 is a diagram illustrating an exemplary configuration of service information;

FIG. 6 is a diagram illustrating an exemplary configuration of resource information according to the first embodiment;

FIG. 7 is a diagram illustrating an exemplary configuration of sensor-and-controller details information;

FIG. 8 is a diagram illustrating an exemplary configuration of coupling information;

FIG. 9 is a diagram illustrating an exemplary configuration of data transfer information;

FIG. 10 is a diagram illustrating an exemplary configuration of service transmission/reception details information;

FIG. 11 is a diagram illustrating an exemplary configuration of candidate course cost information;

FIG. 12 is a diagram illustrating an exemplary configuration of minimum cost course information;

FIG. 13 is a diagram illustrating an exemplary configuration of route details information;

FIG. 14 is a diagram illustrating an exemplary configuration of edge computer course combination information;

FIG. 15 is a flow chart illustrating an example of processing by a configuration information input unit;

FIG. 16 is a flow chart illustrating an example of processing by a resource information collection unit;

FIG. 17 is a flow chart illustrating an example of processing by a service information acquisition unit;

FIG. 18 is a flow chart illustrating an example of processing by an arrangement measurement unit;

FIG. 19 is a flow chart illustrating continuation of the processing illustrated in FIG. 18;

FIG. 20 is a flow chart illustrating details of processing of S411 of FIG. 19;

FIG. 21 is a flow chart illustrating continuation of the processing illustrated in FIG. 20;

FIG. 22 is a flow chart illustrating details of processing of S502 of FIG. 20;

FIG. 23 is a flow chart illustrating details of processing of S513 of FIG. 20;

FIG. 24 is a flow chart illustrating an example of processing by a result output unit;

FIG. 25 is a flow chart illustrating an example of processing by a service arrangement unit;

FIG. 26 is a diagram illustrating an exemplary configuration of a management sever according to a second embodiment;

FIG. 27 is a diagram illustrating an exemplary configuration of resource information according to the second embodiment;

FIG. 28 is a diagram illustrating an exemplary configuration of service information according to the second embodiment;

FIG. 29 is a flow chart illustrating an example of processing by a limit value monitoring unit;

FIG. 30 is a flow chart illustrating an example of processing by a service rearrangement selection unit;

FIG. 31 is a flow chart illustrating an example of processing by an arrangement measurement unit according to the second embodiment;

FIG. 32 is a flow chart illustrating continuation of the processing of FIG. 31;

FIG. 33 is a diagram illustrating an exemplary configuration of a management sever according to a third embodiment; and

FIG. 34 is a flow chart illustrating an example of processing by a related service selection unit.

### DETAILED DESCRIPTION OF THE EMBODIMENT

Now, description is given of an embodiment of the present invention with reference to the drawings.

### First Embodiment

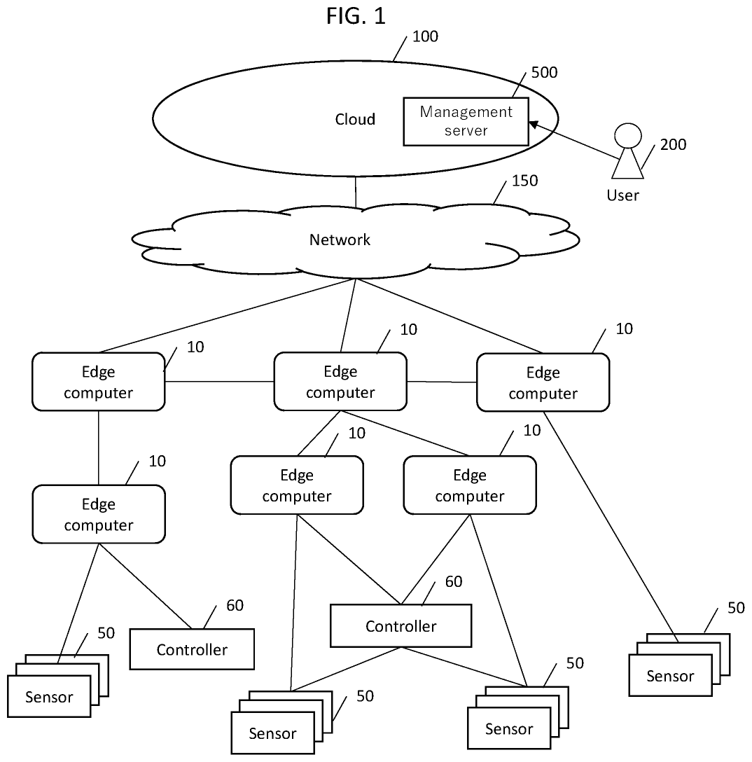

FIG. 1 is a diagram illustrating an exemplary configuration of a computing system according to a first embodiment.

A computing system according to this embodiment includes a sensor 50, a controller 60, and an edge computer 10, which can be coupled to both of the sensor 50 and the controller 60 directly or indirectly, and has a resource for processing of analyzing sensor data and generating an instruction signal for control.

For example, the computing system includes a cloud 100, the edge computer 10, the controller 60, and the sensor 50. The sensor 50 and the controller 60 are coupled to at least one edge computer 10. The edge computer 10 is coupled to a network 150 directly or via another edge computer 10, and is coupled to the cloud 100 via the network 150.

The sensor 50 measures a temperature, a pressure, or other parameters of a device, for example. The controller 60 controls the temperature or pressure of a device, for example. Sensor data measured by the sensor 50 is analyzed by any one of the edge computer 10 and the cloud 100, and instruction data based on the result of analysis is transmitted to the controller 60, and the controller 60 executes control based on the instruction data. The edge computer 10 is placed between the cloud 100 and the sensor 50, and analyses sensor data received from the sensor 50 and transmits instruction data based on the result of analysis to the controller 60. Another edge computer 10 may relay data between the sensor 50 and the edge computer 10 analyzing the sensor data, and between the edge computer 10 and the controller 60 executing control based on the instruction data. Furthermore, sensor data may be analyzed on the cloud 100.

A management server 500, which is an example of a computing service management apparatus, is provided in the cloud 100. The management server 500 supports deployment of a service in the computing system in a service of executing control by the controller 60 based on data acquired by the sensor 50. Deployment of a service means operating a software program of the service by using a resource of the computing system or a computer. A user 200 can use the management server 500 to appropriately deploy a service in the computing system. In the following description, deployment may also be referred to as “arrangement”. The configuration of providing the management server 500 on the cloud 100 is one example, and various kinds of other configurations may be adopted. For example, it is possible to adopt a system configuration in which the management server 500 is arranged near the edge computer 10 as on-premises, and is coupled to the network 150.

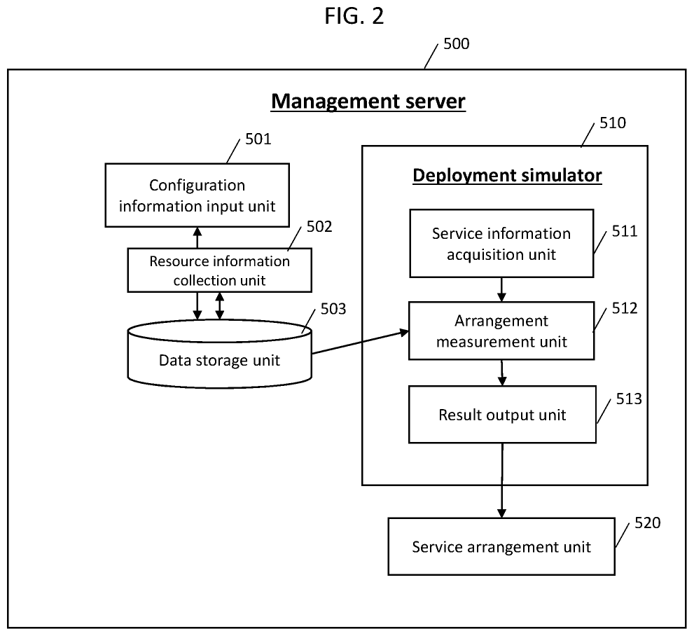

FIG. 2 is a diagram illustrating an exemplary configuration of the management sever.

The management server 500 has functions of a data storage unit 503, a configuration information input unit 501, a resource information collection unit 502, a service information acquisition unit 511, an arrangement measurement unit 512, a result output unit 513, and a service arrangement unit 520. The service information acquisition unit 511, the arrangement measurement unit 512, and the result output unit 513 may be functions included in a deployment simulator 510.

The data storage unit 503 stores data generated and used by the management server 500.

The configuration information input unit 501 acquires configuration information on the entire computing system. The configuration information indicates the edge computer 10, the sensor 50, and each apparatus such as a controller, which are included in the computing system, and a configuration of coupling among the apparatus.

The resource information collection unit 502 acquires resource information indicating an available resource that is available among resources included in the respective edge computers 10.

The service information acquisition unit 511 acquires, for a target service to be deployed in the computing system, service information including a target sensor that acquires data to be used by the target service, a required resource required for the target service, and a target controller that executes control by the target service. The service information acquisition unit 511 generates and displays an input UI (user interface), and acquires the service information on the target service from the user 200 via the input UI.

The arrangement measurement unit 512 acquires data transfer information indicating a course through which data used by a co-existing service co-existing with the target service in the computing system flows, sets a computer that covers the required resource by the available resource as a candidate computer, extracts a candidate course, which is a combination of an input course from the target sensor to the candidate computer and an output course from the candidate computer to the target controller, and calculates, for the candidate course and at least the input course, a total cost for causing data to be used by the target service to flow, by considering using data caused to flow by the co-existing service for the target service for a path through which the data to be used by the target service is caused to flow by the co-existing service. When the data to be used by the target service is already caused to flow through a path included in a candidate course of the target service by a co-existing service, the target service uses the data in a shared manner, to thereby be able to suppress increase in network cost and suppress the total cost. In this description, regarding both of the input course and the output course, an example of considering using data caused to flow by a co-existing service for the target service for a path through which the data to be used by the target service is caused to flow by the co-existing service is given. However, other configurations may be adopted. As a general example, the input course often includes a path for which data caused to flow by a co-existing service can be used by the target service. In view of this, regarding the input course, a total cost for causing the data to be used by the target service to flow may be calculated by considering using data caused to flow by a co-existing service for the target service for a path through which the data to be used by the target service is caused to flow by the co-existing service.

The result output unit 513 generates and displays an output UI including a result of calculation by the arrangement measurement unit 512, and acquires an instruction for deployment from the user 200 via the output UI.

The service arrangement unit 520 deploys a service in the computing system based on the instruction from the user 200.

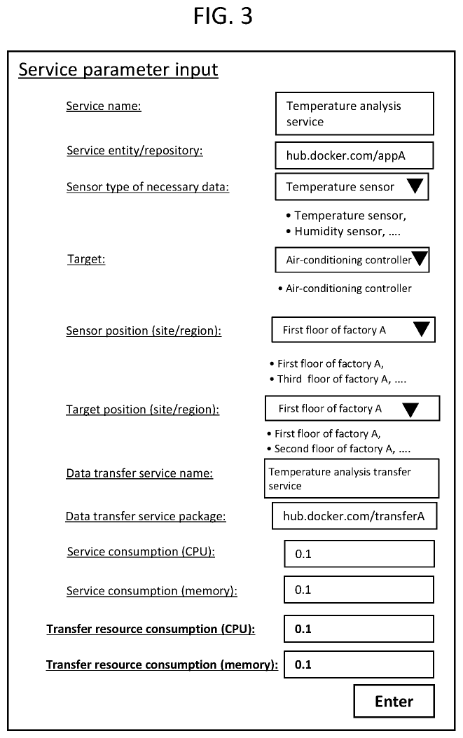

FIG. 3 is a diagram illustrating an exemplary configuration of the input UI.

The input UI is a UI for inputting each parameter included in service information on a computing service.

For example, the input UI receives, as parameters, input of a service name of the computing service, a service entity and repository, a sensor type of the sensor 50 that measures necessary data, a target being the controller 60 that executes control, a sensor position, a target position, resource consumption amounts of a CPU and a memory, a data transfer service name of a transfer service to be used for data transfer of the computing service, a data transfer service package being a software program that implements the transfer service, and resource consumption amounts of the CPU and the memory used for data transfer.

In this embodiment, when a certain computing service is deployed, and another edge computer 10 transfers data between the sensor 50 and the edge computer 10 in which the computing service is deployed, the edge computer 10, which transfers the data, deploys the transfer service for implementing transfer of data. The input UI of FIG. 3 also receives the service information on the transfer service.

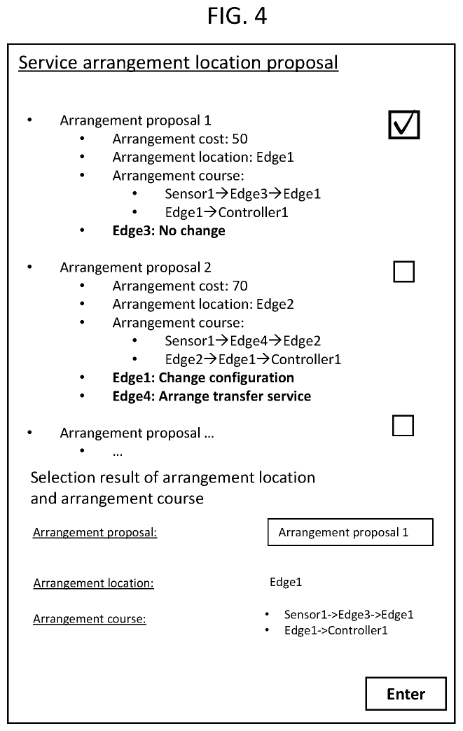

FIG. 4 is a diagram illustrating an exemplary configuration of the output UI.

The output UI is an UI for displaying a result of calculation by the arrangement measurement unit 512, and receiving a selection from the user 200.

The output UI displays, for example, an arrangement cost, an arrangement location, and an arrangement course for at least one arrangement proposal that has identified an edge computer (arrangement location) in which the computing service is to be deployed and a course (arrangement course) through which data is transferred.

The arrangement cost indicates a value of a cost relating to increase in communication volume in the computing system in a case where the computing service is deployed in accordance with the arrangement proposal. The arrangement cost indicates that the increase in communication volume becomes smaller as the value becomes smaller, for example.

The arrangement location indicates a location of an edge computer in which the computing service is to be deployed.

The arrangement course indicates a course (hereinafter referred to as “input course”) of data to be transmitted from the sensor 50 to the edge computer 10 at the arrangement location, and a course (hereinafter referred to as “output course”) of data to be transmitted from the edge computer 10 at the arrangement location to the controller 60.

When a computing service is deployed in accordance with an arrangement proposal, and a change is made to an edge computer other than the edge computer in which the computing service is deployed, the details of change are also displayed.

The user 200 can select a desired arrangement proposal via the output UI to deploy the computing service in the appropriate edge computer 10. The arrangement proposal is selected by checking a checkbox and pressing a confirm button.

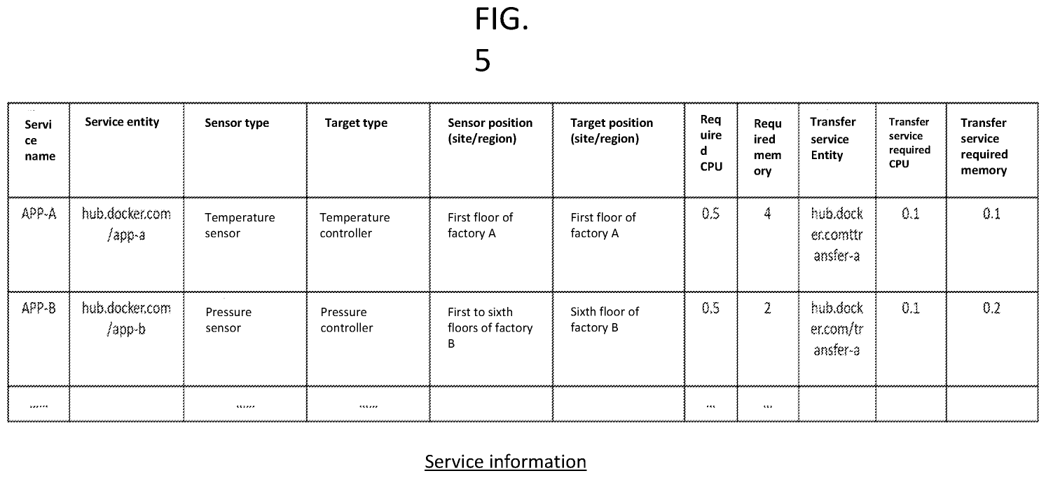

FIG. 5 is a diagram illustrating an exemplary configuration of the service information. The service information includes information on deployment of a computing service.

The service information is managed by the data storage unit 503 of the management server 500 on the cloud 100.

The service information includes, as parameters, a service name, a service entity, a sensor type, a target type, a sensor position, a target position, a required CPU, a required memory, a transfer service entity, a transfer service required CPU, and a transfer service required memory.

The service name indicates a name of a deployed computing service. The service entity indicates an entity of the computing service indicated by the service name.

The sensor type indicates a type of the sensor 50 that measures data to be used by the computing service of the service name. The target type indicates a type of a controller (target) that is controlled in the computing service of the service name.

The sensor position indicates a position at which the sensor 50 of the sensor type is installed in the computing service of the service name. The target position indicates a position at which the controller 60 of the target type is installed in the computing service of the service name.

The required CPU indicates a resource amount of a CPU that is required by the computing service of the service name. The required memory indicates a resource amount of a memory that is required by the computing service of the service name.

The transfer service entity indicates an entity of a transfer service for transferring data in the computing service of the service name. The transfer service required CPU indicates a resource amount of a CPU required by the transfer service. The transfer service required memory indicates a resource amount of a memory required by the transfer service.

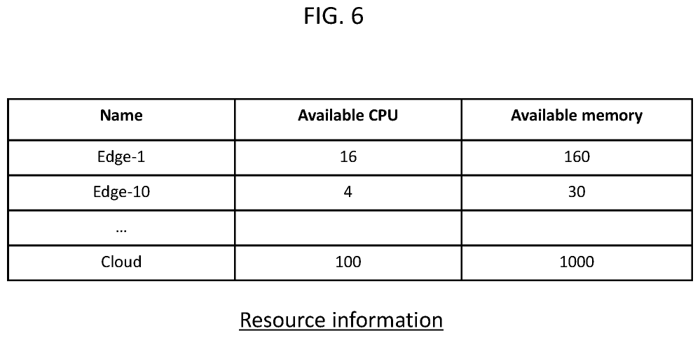

FIG. 6 is a diagram illustrating an exemplary configuration of the resource information. The resource information includes information on resource amounts of a CPU and a memory that are available in the edge computer 10 or the cloud 100. The resource information is managed by the data storage unit 503 of the management server 500. The resource information collection unit 502 of the management server 500 monitors the entire edge computing system, and updates the resource information on each edge computer 10 in real time. The computing service can be deployed not only in the edge computer 10 but also in the cloud 100.

The resource information includes, as parameters, a name, an available CPU, and an available memory. The name indicates an identification name of a computer that provides resources. The available CPU indicates an amount of available resources of a CPU in a computer indicated by the name. The available memory indicates an amount of available resources of a memory in a computer indicated by the name.

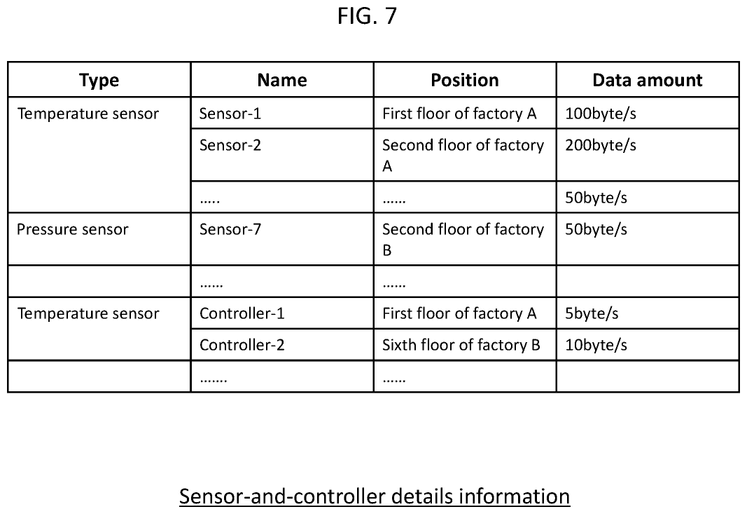

FIG. 7 is a diagram illustrating an exemplary configuration of sensor-and-controller details information. The sensor-and-controller details information includes detailed information on a sensor and a controller included in the computing system. The sensor-and-controller details information is managed by the data storage unit 503 of the management server 500.

The sensor-and-controller details information includes, as parameters, a type, a name, a position, and a data amount. The type indicates the type of a sensor or a controller. The name indicates a name of the sensor or the controller. The position indicates the position of the sensor 50 or the controller 60 indicated by the name. The data amount indicates an amount of data output by the sensor 50 indicated by the name per unit time, or an amount of data input to the controller 60 per unit time.

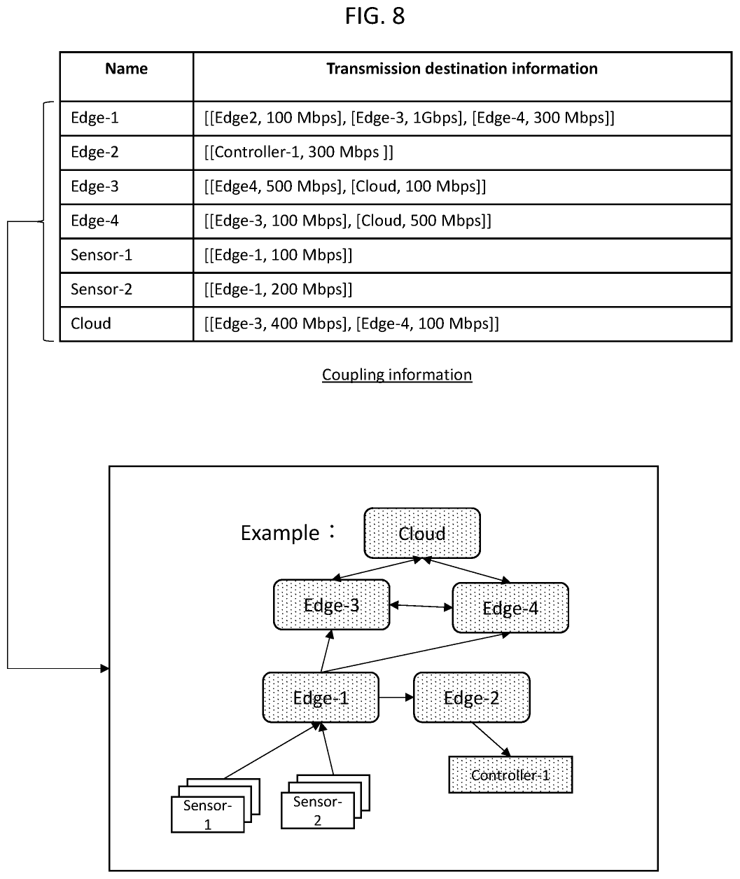

FIG. 8 is a diagram illustrating an exemplary configuration of coupling information. The coupling information includes information indicating how the edge computer 10, the sensor 50, the controller 60, and the cloud 100 are coupled to one another. The coupling information is managed by the data storage unit 503 of the management server 500. A schematic diagram on the lower side of FIG. 8 is an illustration of a coupling relationship indicated by the coupling information on the upper side of FIG. 8.

The coupling information includes, as parameters, a name and transmission destination information. The name indicates the name of the edge computer 10, the sensor 50, the controller 60, or the cloud 100. The transmission destination information indicates another edge computer 10, sensor 50, controller 60, or cloud 100 to which the edge computer 10, the sensor 50, the controller 60, or the cloud 100 indicated by the name can transmit data directly. In addition, the transmission destination information indicates a transmission bandwidth that is available when the edge computer 10, the sensor 50, the controller 60, or the cloud 100 indicated by the name transmits data to another edge computer 10, sensor 50, controller 60, or cloud 100. For example, the second line of the coupling information illustrated in FIG. 8 indicates that an edge computer “Edge-2” can transmit data to a controller “Controller-1”, and the transmission bandwidth is “300 Mbps”.

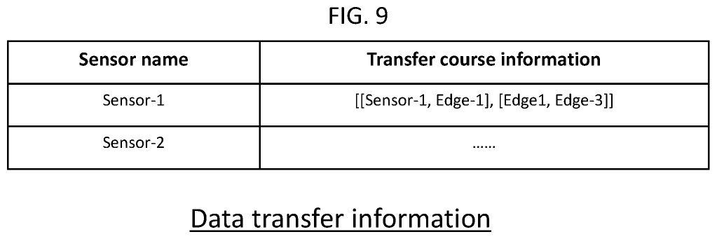

FIG. 9 is a diagram illustrating an exemplary configuration of the data transfer information. The data transfer information includes information indicating through which course data output from the sensor 50 is currently transferred. The data transfer information is managed by the data storage unit 503 of the management server.

The data transfer information includes, as parameters a sensor name and transfer course information. The sensor name indicates an identification name of the sensor 50. The data transfer information indicates a current transfer course of data output from a sensor of the sensor name. For example, the first line of the data transfer information illustrated in FIG. 9 indicates that data output from a sensor “Sensor-1” is transferred from the sensor “Sensor-1” to the edge computer 10 “Edge-1”, and then is transferred from the edge computer 10 “Edge-1” to the edge computer “Edge-3”.

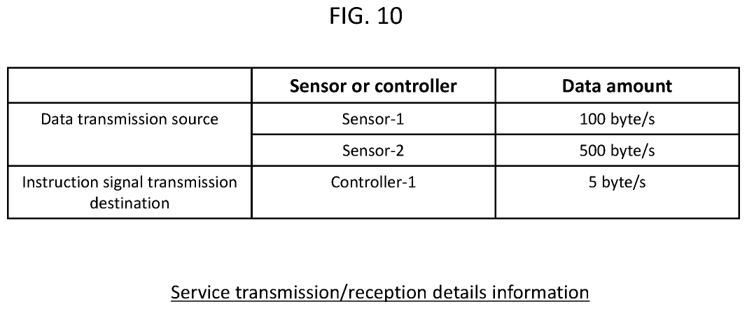

FIG. 10 is a diagram illustrating an exemplary configuration of service transmission/reception details information. The service transmission/reception details information is information indicating the sensor 50 serving as a transmission source or the controller 60 serving as a transmission destination of data to be transmitted/received in the computing service, and an amount of data to be transmitted/received per unit time. The service transmission/reception details information is generated by the arrangement measurement unit 512 of the deployment simulator 510 simulating a state of deploying the computing service.

The service transmission/reception details information indicates a sensor name of the sensor 50 serving as a data transmission source in the computing service, a data amount per unit time of data to be transmitted from the sensor 50 of the sensor name, a controller name of the controller 60 serving as a transmission destination of an instruction signal for control, and a data amount per unit time of an instruction signal to be transmitted to the controller 60 of the controller name.

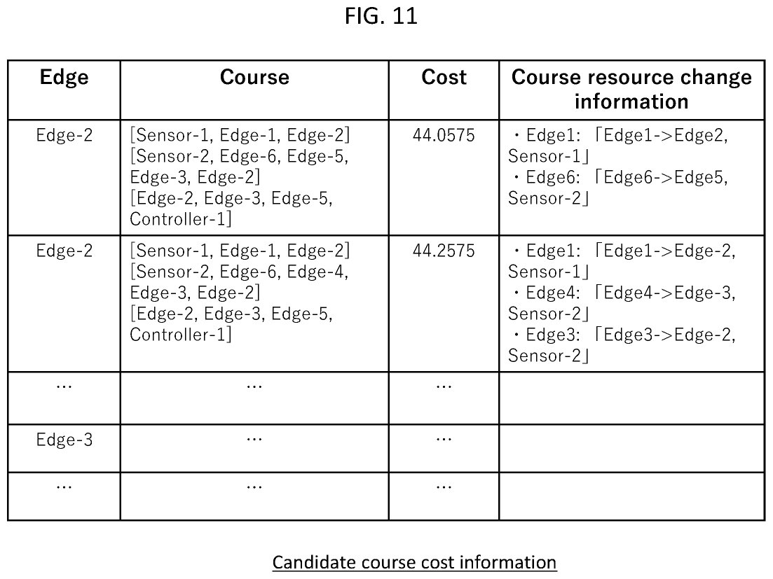

FIG. 11 is a diagram illustrating an exemplary configuration of candidate course cost information.

The candidate course cost information includes information indicating a cost of a candidate course that passes through the edge computer 10. The candidate course cost information is generated by the arrangement measurement unit 512 of the deployment simulator 510 simulating a state of deploying the computing service.

The candidate course cost information includes, as parameters, an edge name being a name of the edge computer 10 in which the computing service is deployed, a candidate course being a course from the sensor 50 to the controller 60, a cost that increases due to flow of data to be used by the computing service for the candidate course, and course resource change information being information indicating a change in resource that occurs due to data transfer of the edge computer 10 on the course through addition of the candidate course.

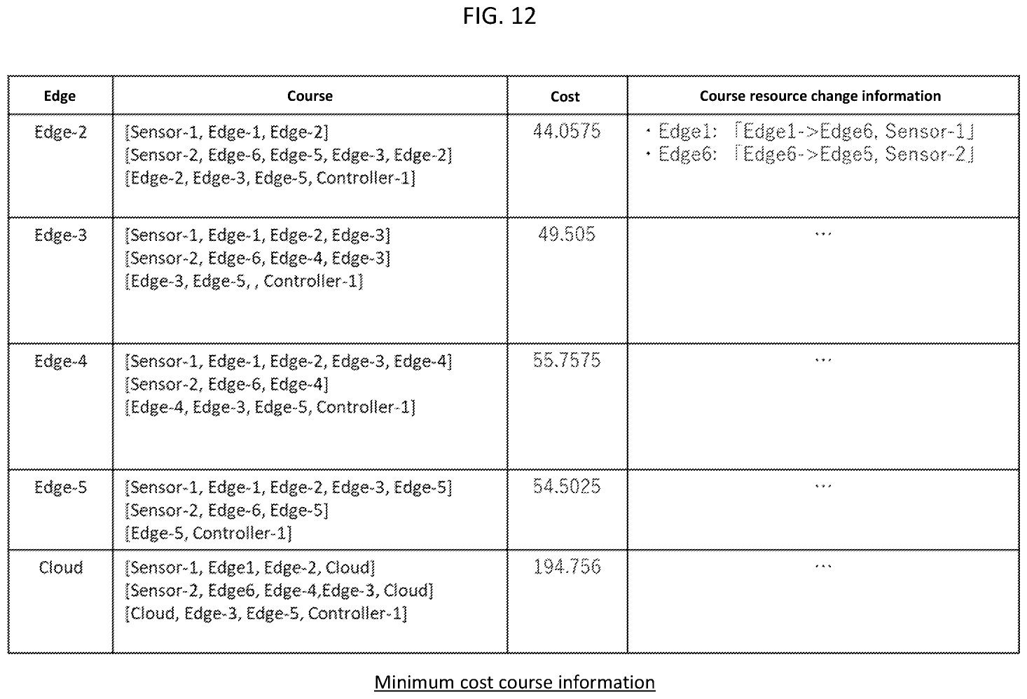

FIG. 12 is a diagram illustrating an exemplary configuration of minimum cost course information. The minimum cost course information is information that has extracted a candidate course that minimizes a cost for each candidate edge computer 10 in which the computing service is deployed. The minimum cost course information includes information indicating a course with a minimum cost among candidate courses for each candidate edge computer 10 in which the computing service is deployed. The minimum cost course information is generated by the arrangement measurement unit 512 of the deployment simulator 510 simulating a state of deploying the computing service.

The minimum cost course information and the above-mentioned candidate course cost information have common parameters.

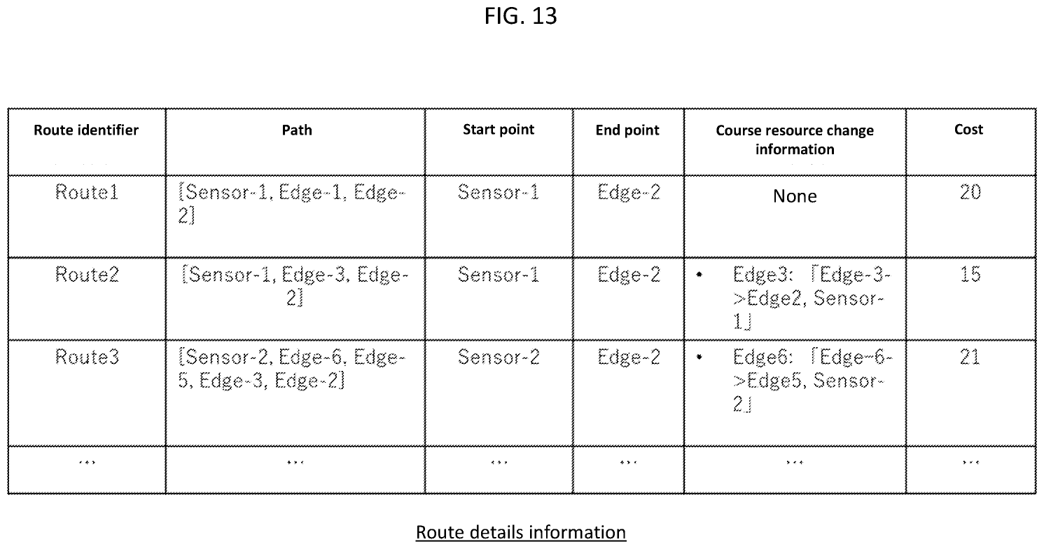

FIG. 13 is a diagram illustrating an exemplary configuration of route details information.

The route details information includes detailed information on a course (route) from a certain start point to a certain end point. The arrangement measurement unit 512 of the deployment simulator 510 simulates a state of deploying the computing service, and generates the route details information for each combination of the start point and the end point on the candidate course. The combination of the start point and the end point is, for example, a combination of the sensor 50 and the edge computer 10 or a combination of the edge computer 10 and the controller 60.

The route details information includes, as parameters, a route identifier, a path, a start point, an end point, a course resource information change, and a cost.

The route identifier is information for identifying a route. The route herein refers to an individual course obtained by dividing the entire course from the sensor 50 to the controller 60 into an input course from the sensor 50 to the edge computer 10 and an output course from the edge computer 10 to the controller 60.

The path is information indicating paths forming a route of the route identifier. The start point is information indicating a start point of a course of the route identifier. The end point is information indicating an end point of a course of the route identifier.

The course resource change information is information indicating a change in resource that occurs due to data transfer of the edge computer 10 on the route through addition of the candidate course.

The cost is information indicating a cost of the route indicated by the route identifier.

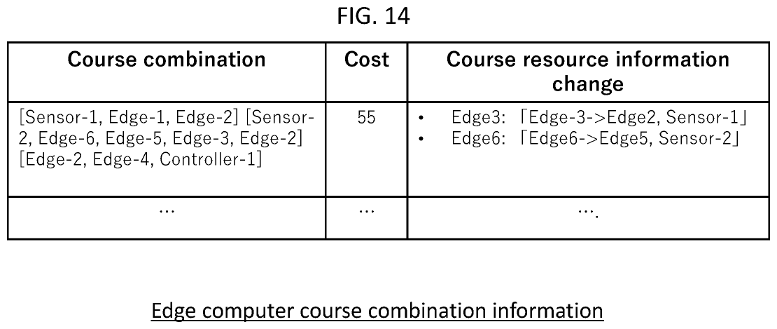

FIG. 14 is a diagram illustrating an exemplary configuration of edge computer course combination information.

The edge computer course combination information includes information on a combination of an input course (route) and an output course (route) for a course from the sensor 50 to the controller 60. In other words, the edge computer course combination information includes information on an entire course from the sensor 50 to the controller 60, which is formed by combining the upstream route and the downstream route illustrated in FIG. 13.

The edge computer course combination information includes, as parameters, a combination of courses indicating courses from the sensor 50 to the controller 60, a cost of the combination of courses, a course resource information change indicating a change that occurs in the resources of edge computers on courses in a case where the combination of courses is used.

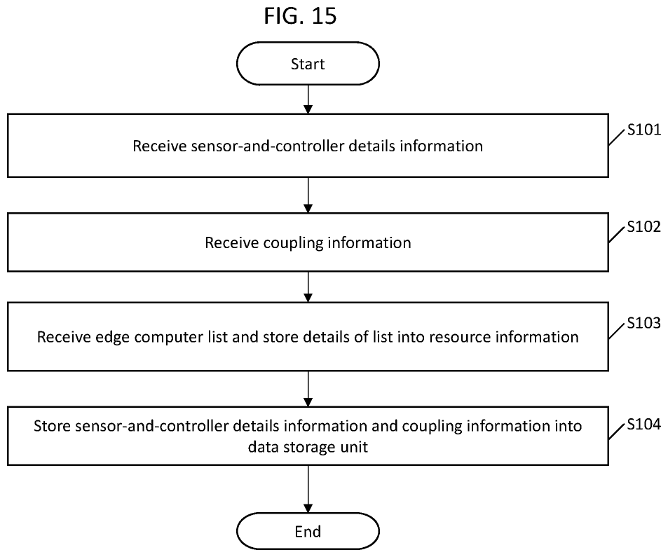

FIG. 15 is a flow chart illustrating an example of processing by the configuration information input unit.

The configuration information input unit 501 receives sensor-and-controller details information defined by the user 200 (S101). The configuration information input unit 501 receives coupling information (refer to FIG. 8) defined by the user 200 (S102).

Furthermore, the configuration information input unit 501 acquires an edge computer list indicating a list of edge computers 10 defined by the user 200. Then, the configuration information input unit 501 generates a vacant table of resource information, and stores the name of the edge computer 10 included in the edge computer list into a column of the data item “name” of the resource information (S103).

Furthermore, the configuration information input unit 501 stores the sensor-and-controller details information received in S101 and the coupling information received in S102 into the data storage unit 503 (S104), and finishes the processing.

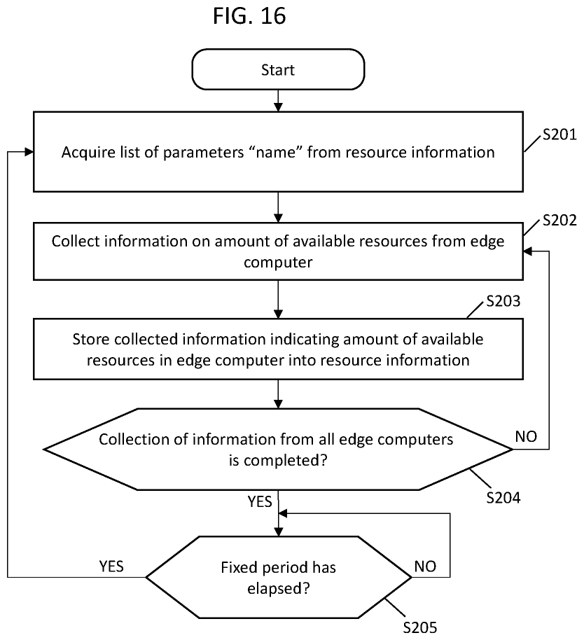

FIG. 16 is a flow chart illustrating an example of processing by the resource information collection unit.

The resource information collection unit 502 acquires a list (hereinafter referred to as “edge computer list”) of parameters “name” from the resource information (refer to FIG. 6) of the data storage unit 503 (S201).

The resource information collection unit 502 selects the edge computer 10 registered in the edge computer list acquired in S201, and collects information indicating resource amounts of a CPU and a memory that are available in the edge computer 10 (S202). Then, the resource information collection unit 502 stores the amount of resources available in each edge computer 10 collected in S202 into the resource information of the data storage unit 503 (S203).

The resource information collection unit 502 determines whether collection of information indicating the amount of available resources from all the edge computers 10 has been finished (S204). When the edge computer 10 for which the information has not been collected yet remains (S204: NO), the resource information collection unit 502 returns to the processing of S202, selects the next edge computer 10, and continues the processing. When the information has been collected from all the edge computers 10 (S204: YES), the resource information collection unit 502 executes the next processing of S205.

The resource information collection unit 502 waits until a fixed period (e.g., 5 minutes) has elapsed (S205: NO), and after the fixed period has elapsed (S205: YES), the resource information collection unit 502 returns to the processing of S201. In other words, the resource information collection unit 502 collects information indicating the amount of available resources from the edge computer 10 periodically, and stores the information into the resource information.

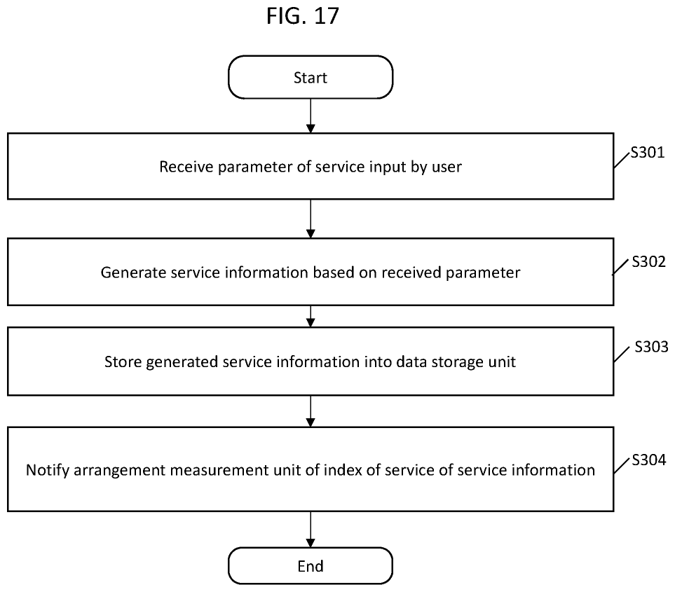

FIG. 17 is a flow chart illustrating an example of processing by the service information acquisition unit.

The service information acquisition unit 511 receives a parameter of the computing service input by the user 200 (S301). The user 200 may input a parameter of the computing service to be deployed in the computing system via the input UI illustrated in FIG. 3. The service information acquisition unit 511 generates service information based on the parameter received in S301 (S302). Then, the service information acquisition unit 511 stores the generated service information into the data storage unit 503 (S303). The service information acquisition unit 511 notifies the arrangement measurement unit 512 of an index of the service of the service information (S304), and finishes the processing.

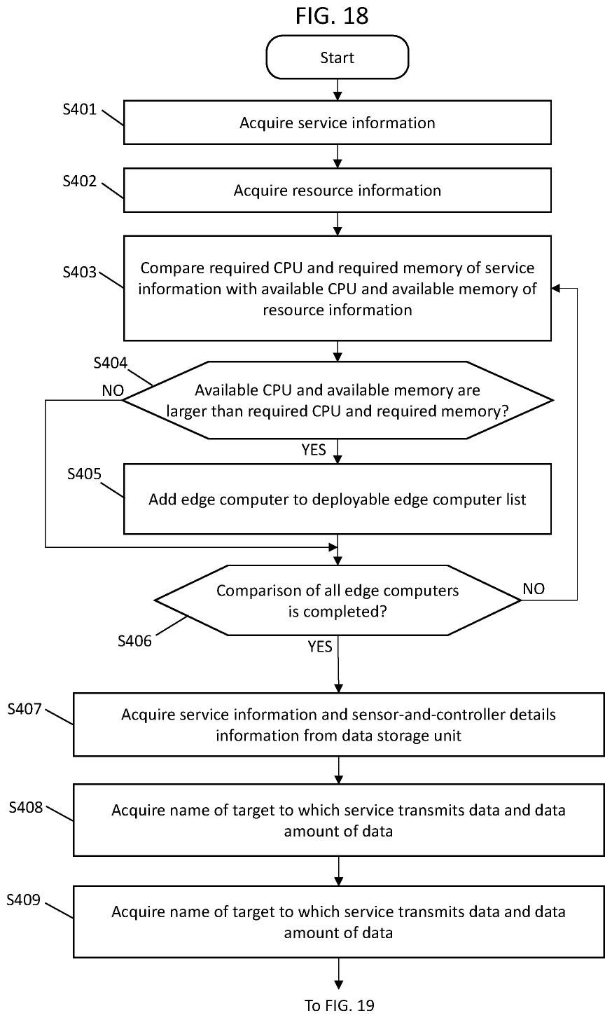

FIG. 18 to FIG. 23 are flow charts illustrating an example of processing by the arrangement measurement unit.

In FIG. 18, the arrangement measurement unit 512 refers to the index notified from the service information acquisition unit 511, and acquires service information from the data storage unit 503 (S401). Furthermore, the arrangement measurement unit 512 acquires resource information from the data storage unit 503 (S402).

Next, the arrangement measurement unit 512 compares values of the required CPU and the required memory included in the service information with values of the available CPU and the available memory included in the resource information (S403).

The arrangement measurement unit 512 determines whether the value of the available CPU included in the resource information is larger than the value of the required CPU included in the service information, and the value of the available memory included in the resource information is larger than the value of the required memory included in the service information (S404). In other words, it is determined whether the amount of resources available in the edge computer 10 is larger than the amount of resources required by the service to be deployed.

When the value of the available CPU in the edge computer 10 is equal to or smaller than the value of the required CPU required by the service to be deployed, or the value of the available memory in the edge computer 10 is equal to or smaller than the value of the required memory required by the service to be deployed (S404: NO), the arrangement measurement unit 512 proceeds to the processing of S406.

When the value of the available CPU in the edge computer 10 is larger than the value of the required CPU required by the service to be deployed, and the value of the available memory in the edge computer 10 is larger than the value of the required memory required by the service to be deployed (S404: YES), the arrangement measurement unit 512 executes the next processing (S405). In other words, the arrangement measurement unit 512 adds the edge computer 10 to a list (hereinafter referred to as “deployable edge computer list”) of edge computers 10 in which the computing service can be deployed (S405). Then, the arrangement measurement unit 512 proceeds to the processing of S406.

The arrangement measurement unit 512 determines whether comparison of S403 has been performed for all the edge computers 10 (S406). When the edge computer 10 for which comparison of S403 has not been performed yet remains (S406: NO), the arrangement measurement unit 512 returns to the processing of S403, and performs comparison for the remaining edge computers 10. When the arrangement measurement unit 512 has performed comparison of S403 for all the edge computers 10 (S406: YES), the arrangement measurement unit 512 proceeds to the processing of S407.

The arrangement measurement unit 512 acquires the service information and the sensor-and-controller details information from the data storage unit 503 (S407).

The arrangement measurement unit 512 acquires the name of each sensor being a transmission source of sensor data to be used by the computing service and a data amount per unit time of the data from the sensor-and-controller details information based on information of the sensor type and the sensor position in the service information and information of the type and the position in the sensor-and-controller details information (S408).

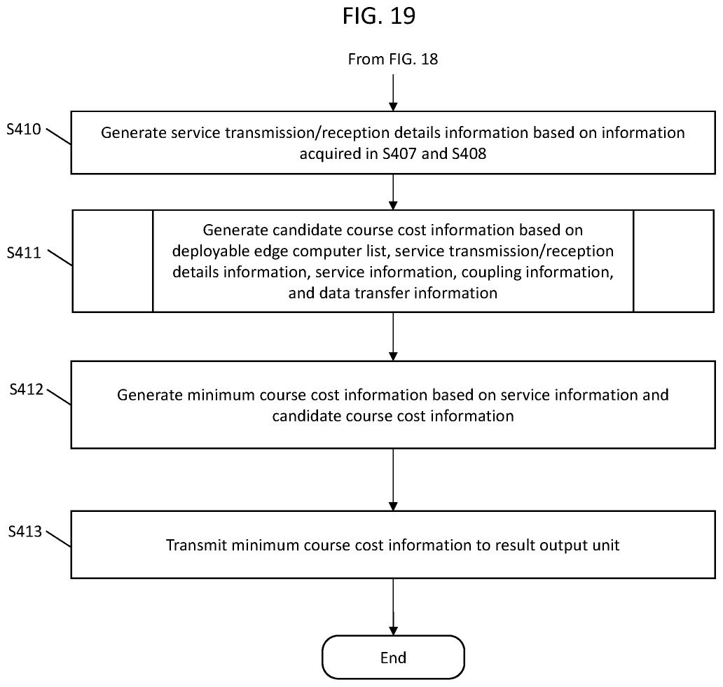

The arrangement measurement unit 512 acquires the name of a target, which is a destination to which the edge computer 10 in which the computing service is deployed transmits data of a control instruction, and the data amount per unit time of the data based on the information of the target type and the target position for a target being the controller 60 of the computing service in the service information, and the information of the type and the position in the sensor-and-controller details information (S409). Then, the arrangement measurement unit 512 proceeds the processing illustrated in FIG. 19.

FIG. 19 is a flow chart illustrating continuation of the processing illustrated in FIG. 18.

The arrangement measurement unit 512 generates service transmission/reception details information based on the information acquired in S408 and S409 of FIG. 18 (S410). In other words, the arrangement measurement unit 512 stores the name of each sensor 50 being a transmission source of data to be used by the computer acquired in S408 and the data amount per unit time of the data into the sensor name and the data amount of “data transmission source” in the service transmission/reception details information. In addition, the arrangement measurement unit 512 stores the name of a target being the controller 60, which is a destination to which data of a control instruction of the computing service is transmitted, and the data amount per unit time of the data acquired in S409 into the controller name and the data amount of “instruction signal transmission destination” in the service transmission/reception details information.

The arrangement measurement unit 512 generates candidate course cost information based on the deployable edge computer list generated in S405, the service transmission/reception details information, the service transmission/reception details information, the service information coupling information, and the data transfer information (S411). Details of the processing of S411 are described later.

Next, the arrangement measurement unit 512 generates minimum cost course information based on the service information and the candidate course cost information generated in S411 (S412). At this time, the arrangement measurement unit 512 extracts a candidate course with a minimum cost for each candidate edge computer in which the computing service is to be deployed, and records the extracted candidate course into the minimum cost course information.

Then, the arrangement measurement unit 512 transmits the minimum cost course information generated in S412 to the result output unit 513 (S413), and finishes a series of processing.

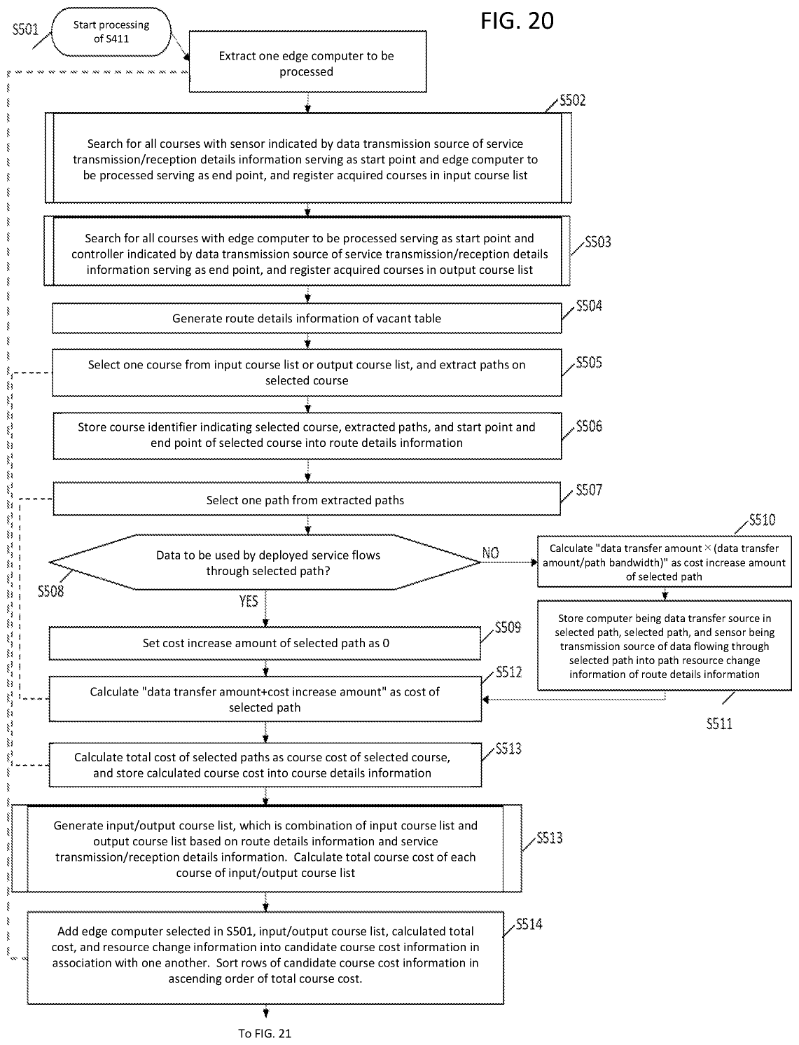

FIG. 20 is a flow chart illustrating details of processing of S411 of FIG. 19.

The arrangement measurement unit 512 selects one edge computer 10 to be processed from the deployable edge computer list (S501).

The arrangement measurement unit 512 sets the sensor 50 indicated by the data transmission source of the service transmission/reception details information as a start point, and the edge computer 10 to be processed as an end point, and searches for all the courses from the start point to the end point with reference to the coupling information by using depth priority search. The arrangement measurement unit 512 registers all the acquired courses in a list (hereinafter referred to as “input course list”) of courses from the data transmission source to the edge computer 10 (S502).

The arrangement measurement unit 512 sets the edge computer 10 to be processed as a start point, and the controller 60 indicated by the instruction signal transmission destination of the service transmission/reception details information as an end point, and searches for all the courses from the start point to the end point with reference to the coupling information by using depth priority search. The arrangement measurement unit 512 registers all the acquired courses in a list (hereinafter referred to as “output course list”) of courses from the edge computer 10 to the instruction signal transmission destination (S503).

The arrangement measurement unit 512 creates a vacant table of the route details information (S504).

The arrangement measurement unit 512 selects one course from the input course list or the output course list, sets the course as a selected course, and extracts paths forming the selected course (S505). The path is individual coupling between a device and a device such as the edge computer 10, the sensor 50, and the controller 60. The course from a start point to an end point is formed by one or more paths. The arrangement measurement unit 512 stores a course identifier indicating the selected course, the paths extracted in S505, and the start point and end point of the course selected in S505 into the route details information (S506).

Then, the arrangement measurement unit 512 selects one path from the paths extracted in S505 as a selected path (S507). Then, the arrangement measurement unit 512 determines whether data to be used by the computing service to be deployed flows through the selected path based on the transfer course information of the data transfer information (S508).

When the data to be used by the computing service to be deployed already flows through the selected path (S508: YES), the arrangement measurement unit 512 sets the cost increase amount of the selected path as 0 (S509), and proceeds to the processing of S512.

On the other hand, when the data to be used by the service to be deployed does not flow through the selected path (S507: NO), the arrangement measurement unit 512 calculates “data transfer amount×(data transfer amount/path bandwidth)” as the cost increase amount of the selected path (S510). The data transfer amount is a data amount per unit time of data caused to flow through the path when the computing service is deployed. Then, the arrangement measurement unit 512 stores the computer being a data transfer source in the selected path, the selected path, and the sensor 50 being a transmission source of data flowing through the selected path into the course resource change information of the route details information (S511), and proceeds to the processing of S512.

The arrangement measurement unit 512 calculates “data transfer amount+cost increase amount” as the cost of the selected path (S512). The data transfer amount may also be referred to as a path basic cost. The arrangement measurement unit 512 repeats the processing of from S507 to S512 by the same number of times as the number of paths extracted in S507.

The arrangement measurement unit 512 calculates a total cost of selected paths calculated by repetition processing of from S507 to S512 as the cost of the course selected in S505. Then, the arrangement measurement unit 512 stores the calculated course cost into the course cost of the route details information (S513). The arrangement measurement unit 512 repeats the processing of from S505 to S513 by the same number of times as the number of courses included in the input course list and the output course list.

Next, the arrangement measurement unit 512 generates a list (hereinafter referred to as “input/output course list”) of all the courses, which is a combination of the input course list and the output course list based on the route details information and the service transmission/reception details information. Then, the arrangement measurement unit 512 calculates the cost (hereinafter referred to as “total cost”) of each course of the input/output course list (S513). Details of the processing are described later.

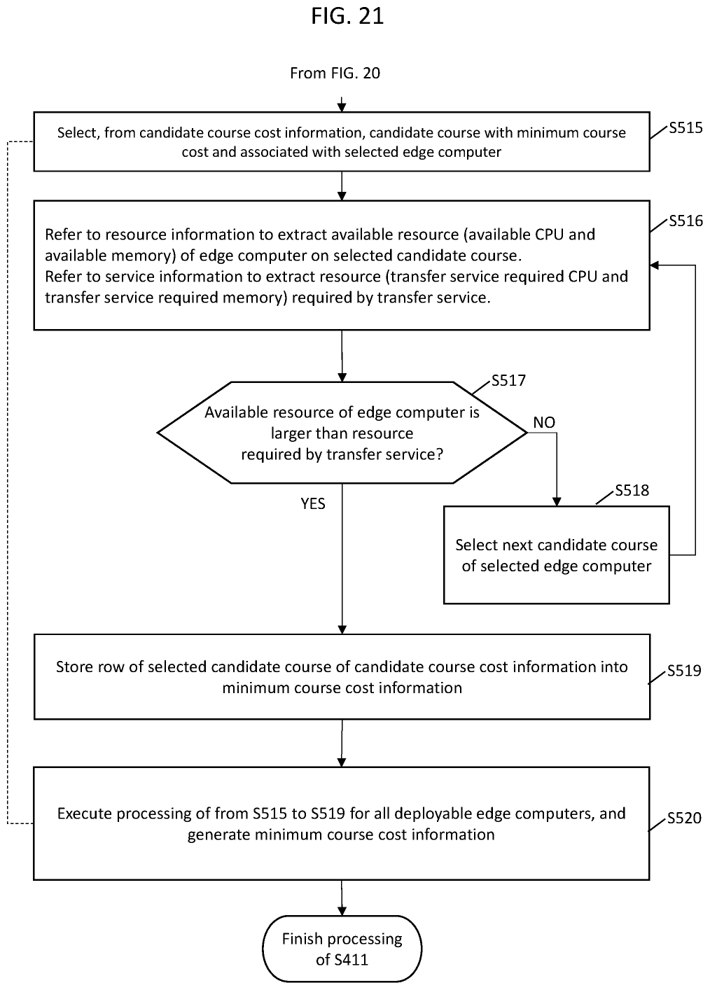

The arrangement measurement unit 512 adds the edge computer 10 selected in S501, the input/output course list, the calculated total cost, and the course resource change information into the candidate course cost information in association with one another (S514). The arrangement measurement unit 512 repeats the processing of from S501 to S514 by the same number of times as the number of edge computers 10 included in the deployable edge computer list. Furthermore, the arrangement measurement unit 512 may sort the rows of the candidate course cost information in ascending order of the total cost in the processing of S514. Next, the arrangement measurement unit 512 proceeds to the processing of FIG. 21.

FIG. 21 is a flow chart illustrating continuation of the processing illustrated in FIG. 20.

The arrangement measurement unit 512 selects one edge computer 10 from the candidate course cost information as a selected edge computer. Then, the arrangement measurement unit 512 selects, from the candidate course cost information, a candidate course with the minimum course cost from among the candidate courses associated with the selected edge computer (S515).

The arrangement measurement unit 512 refers to the resource information to extract an available resource (available CPU and available memory) of the edge computer 10 on the selected candidate course. The arrangement measurement unit 512 refers to the service information to extract a resource (transfer service required CPU and transfer service required memory) required by the transfer service (S516).

Then, the arrangement measurement unit 512 determines whether the extracted available resource of the edge computer 10 is larger than the extracted resource required by the transfer service (S517). When the extracted available resource of the edge computer 10 is equal to or smaller than the extracted resource required by the transfer service (S517: NO), the arrangement measurement unit 512 selects a next candidate course associated with the selected edge computer from the candidate course cost information (S518), and returns to the processing of S515.

On the other hand, when the extracted available resource of the edge computer 10 is larger than the extracted resource required by the transfer service (S517: YES), the arrangement measurement unit 512 proceeds to the processing of S519.

The arrangement measurement unit 512 stores a row of the selected candidate course of the candidate course cost information into minimum course cost information (S519). This is because this selected candidate course is a course that achieves deployment at the minimum cost among the candidate courses.

The arrangement measurement unit 512 executes the processing of from S515 to S519 for all the deployable edge computers 10, and generates minimum course cost information (S520). Then, the arrangement measurement unit 512 finishes the processing of S411 of FIG. 19.

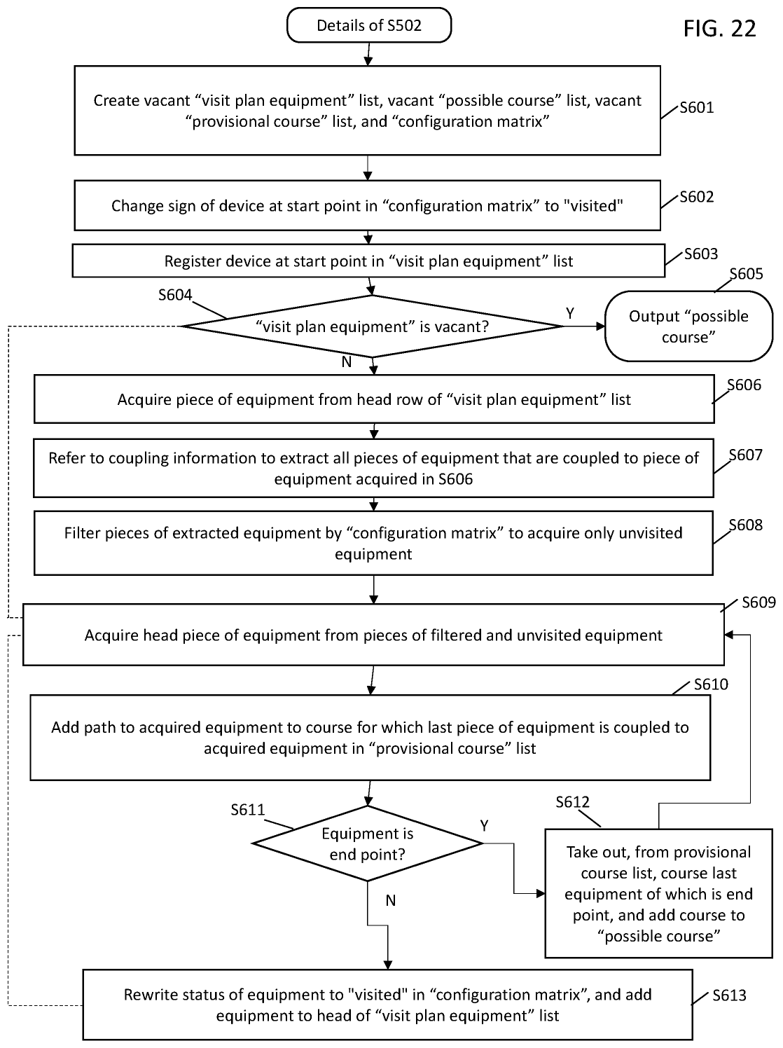

FIG. 22 is a flow chart illustrating details of processing of S502 of FIG. 20. This flow chart is the processing of searching for a course from the sensor 50 serving as a start point to the edge computer 10 serving as an end point, which may be adopted. The processing of S503 of FIG. 20 is the processing of searching for a course from the edge computer 10 serving as a start point to the controller 60 serving as an end point, which may be adopted. The flow chart of FIG. 22 is also used for the processing of S503 of FIG. 20.

The arrangement measurement unit 512 creates a vacant visit plan equipment list, a vacant possible course list, a vacant provisional course list, and a configuration matrix (S601). The possible course list becomes an input course list after a series of processing of FIG. 22.

The visit plan equipment list, the provisional course list, and the configuration matrix are used as provisional data for processing. The visit plan equipment list holds a list of equipment corresponding to start points that are planned to be visited in a series of processing. When a piece of equipment in the visit plan equipment list is visited, that is, when a piece of equipment in the visit plan equipment list is retrieved from the list, the piece of equipment is deleted from the visit plan equipment list. The provisional course list is a list of provisional courses that are used in the processing of going through the course from the start point to the end point. The configuration matrix is information for adding a sign to a visited device (equipment) corresponding to the start point and managing the visited device.

In FIG. 22, the arrangement measurement unit 512 changes the status of a piece of equipment at the start point in the configuration matrix to “visited” (S602). Then, the arrangement measurement unit 512 registers the piece of equipment at the start point in the visit plan equipment list (S603).

Next, the arrangement measurement unit 512 determines whether the visit plan equipment list is vacant (S604). When the visit plan equipment list is vacant (S604: YES), the arrangement measurement unit 512 outputs the possible course list as the input course list (S605), and finishes the processing.

On the other hand, when the visit plan equipment list is not vacant (S604: NO), the arrangement measurement unit 512 acquires a piece of equipment from the head row of the visit plan equipment list (S606).

The arrangement measurement unit 512 refers to the coupling information to extract all the pieces of equipment that are coupled to the piece of equipment acquired in S606 (S607). Furthermore, the arrangement measurement unit 512 filters the pieces of equipment extracted in S607 by the “visited” sign of the configuration matrix, and extracts only the pieces of unvisited equipment (S608).

Next, the arrangement measurement unit 512 acquires a head piece of equipment from the pieces of unvisited equipment extracted by filtering (S609).

The arrangement measurement unit 512 adds a path to be coupled to the piece of equipment acquired in S609 to a course for which the last piece of equipment is coupled to the piece of equipment acquired in S609 (S610).

The arrangement measurement unit 512 determines whether the piece of equipment acquired in S609 is the end point (S611). When the piece of equipment acquired in S609 is the end point (S611: YES), the arrangement measurement unit 512 acquires, from the provisional course list, a course at the end of which the piece of equipment serving as the end point is present, and adds the acquired course to the possible course list (S612). Then, the arrangement measurement unit 512 returns to the processing of S609.

On the other hand, when the piece of equipment acquired in S609 is not the end point (S611: NO), the arrangement measurement unit 512 rewrites the status of the piece of equipment acquired in S609 to “visited” in the configuration matrix. Then, the arrangement measurement unit 512 adds the piece of equipment acquired in S609 to the head of the visit plan equipment list (S613).

The above-mentioned processing of from S609 to S613 is repeated by the same number of times as the number of pieces of filtered unvisited equipment. Furthermore, the processing of from S604 to S613 including the above-mentioned repetition processing of from S609 to S613 is repeated by the same number of times as the number of lists of equipment to be visited.

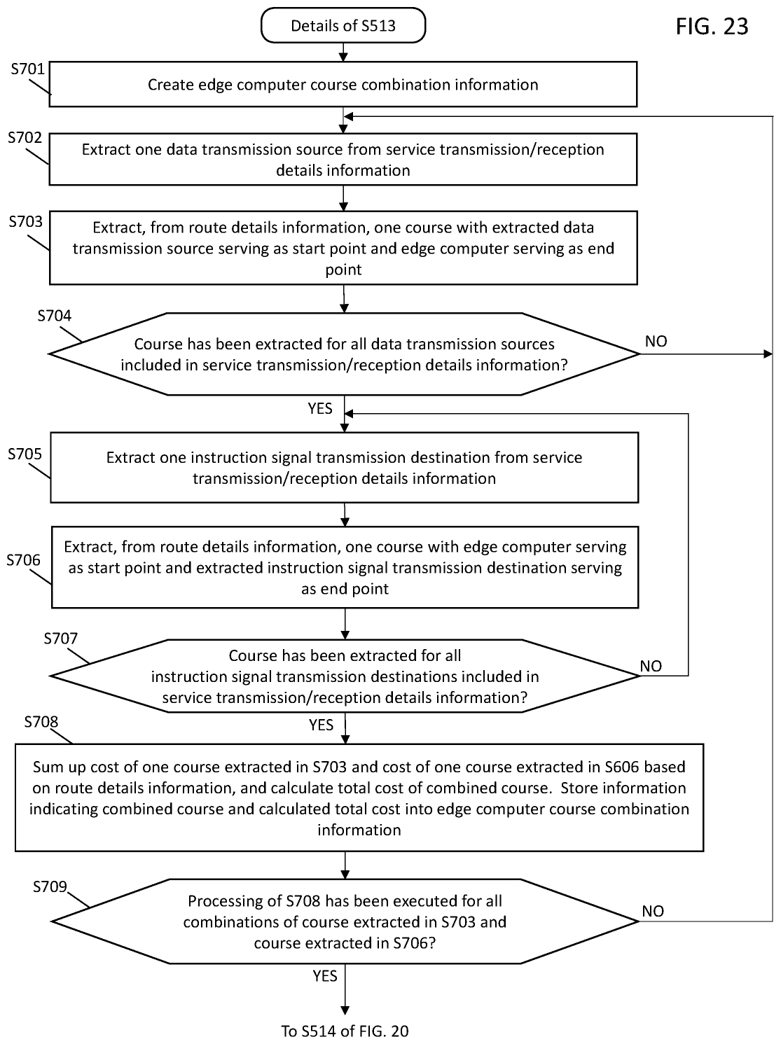

FIG. 23 is a flow chart illustrating details of processing of S513 of FIG. 20. The processing of FIG. 23 is processing of calculating a cost for an entire course, which is a combination of a course from the sensor 50 to the edge computer 10 and a course from the edge computer 10 to the controller.

The arrangement measurement unit 512 creates edge computer course combination information (S701).

Next, the arrangement measurement unit 512 extracts one data transmission source from the service transmission/reception details information (S702). Then, the arrangement measurement unit 512 extracts, from the route details information, one course with the extracted data transmission source serving as the start point and the edge computer 10 serving as the end point (S703).

The arrangement measurement unit 512 determines whether a course has been extracted for all the data transmission sources included in the service transmission/reception details information (S704). When a data transmission source for which a course has not been extracted yet remains (S704: NO), the arrangement measurement unit 512 returns to the processing of S702, and extracts one remaining data transmission source.

On the other hand, when a course has been extracted for all the data transmission sources included in the service transmission/reception details information (S704: YES), the arrangement measurement unit 512 proceeds to the processing of S705. The arrangement measurement unit 512 extracts one instruction signal transmission destination from the service transmission/reception details information (S705). Next, the arrangement measurement unit 512 extracts, from the route details information, one course with the edge computer 10 serving as the start point and the extracted instruction signal transmission destination serving as the end point (S706). Furthermore, the arrangement measurement unit 512 determines whether a course has been extracted for all the instruction signal transmission destinations included in the service transmission/reception details information (S707).

When an instruction signal transmission destination for which a course has not been extracted yet remains (S707: NO), the arrangement measurement unit 512 returns to the processing of S706, and extracts one remaining instruction signal transmission destination. On the other hand, when a course has been extracted for all the instruction signal transmission destinations included in the service transmission/reception details information (S707: YES), the arrangement measurement unit 512 proceeds to the processing of S708.

The arrangement measurement unit 512 sums up the cost of one course extracted in S703 and the cost of one course extracted in S706 based on the route details information, and calculates a total cost of the combined course. Then, the arrangement measurement unit 512 stores information indicating the combined course and the calculated total cost into the edge computer course combination information (S708).

The arrangement measurement unit 512 determines whether the processing of S708 has been executed for all the combinations of the course extracted in S703 and the course extracted in S706 (S709). When a combined course for which the processing of S708 has not been executed yet remains (S709: NO), the arrangement measurement unit 512 returns to the processing of S702. On the other hand, when the processing of S708 has been executed for all the combined courses (S709: YES), the arrangement measurement unit 512 proceeds to the processing of S514 of FIG. 20.

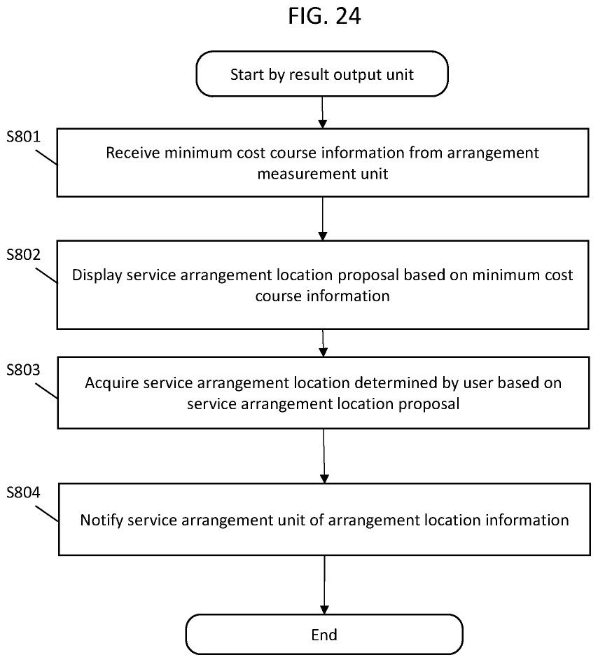

FIG. 24 is a flow chart illustrating an example of processing by the result output unit.

The result output unit 513 receives minimum cost course information from the arrangement measurement unit 512 (S801). Then, the result output unit 513 displays one or more arrangement proposals, which propose a location at which the computing service is to be arranged, as exemplified in FIG. 4 based on the minimum cost course information (S802).

The user 200 refers to the displayed arrangement proposal to determine (select) the location at which the service is to be arranged. The result output unit 513 acquires information indicating which arrangement proposal the user 200 has selected (S803).

Then, the result output unit 513 generates arrangement location information including the arrangement location of the service acquired in S803 and course information on the arrangement location, notifies the service arrangement unit 520 of the arrangement location information (S804), and finishes the processing.

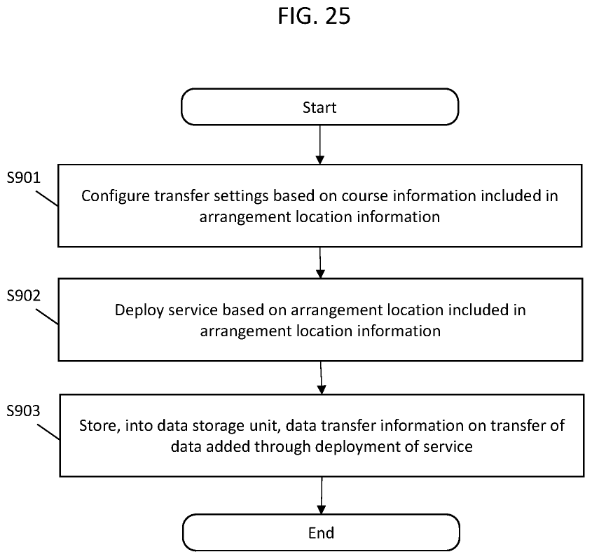

FIG. 25 is a flow chart illustrating an example of processing by the service arrangement unit 520. The service arrangement unit 520 configures transfer settings that enable transmission of data necessary for the computing service to be deployed based on the course information included in the arrangement location information received from the result output unit 513 (S901). Next, the service arrangement unit 520 deploys the computing service in the edge computer 10 indicated by the arrangement location included in the arrangement location information received from the result output unit 513 (S902). Then, the service arrangement unit 520 stores, into the data storage unit 503, data transfer information indicating the settings of transfer of data added through deployment of the computing service (S903).

As described above, according to this embodiment, the arrangement measurement unit 512 acquires data transfer information indicating a course through which data used by a co-existing service co-existing with the target service in the computing system flows, sets a computer that covers the required resource by the available resource as a candidate computer, extracts a candidate course, which is a combination of an input course from the target sensor to the candidate computer and an output course from the candidate computer to the target controller, and calculates, for the candidate course and at least the input course, a total cost for causing data to be used by the target service to flow, by considering using data caused to flow by the co-existing service for the target service for a path through which the data to be used by the target service is caused to flow by the co-existing service. The cost of a course that is newly required for the target service is calculated in consideration of such a possibility that the network may contain a section through which data required for the target service is caused to flow by the co-existing service, and thus it is possible to support implementation of suitable computing by using the network efficiently.

Furthermore, in this embodiment, the arrangement measurement unit 512 determines, for each of a path included in the input course and a path included in the output course, whether the data to be used by the target service is caused to flow through the path by the co-existing service, sets a cost increase amount as zero for a path through which the data to be used by the target service is caused to flow by the co-existing service, sets the cost increase amount as a value that depends on a data amount per unit time of the data to be used by the target service for a path through which the data is not caused to flow by the co-existing service, sets a cost of the path as a sum of a basic cost of the path and the cost increase amount, and calculates a total cost of the candidate course based on a total sum of costs of a path included in the input course and a path included in the output course. The cost increase amount is set as zero for a path through which the data required for the target service is caused to flow by the co-existing service, and thus it is possible to appropriately calculate the cost of the candidate course due to deployment of the target service.

Furthermore, in this embodiment, the arrangement measurement unit 512 sets the basic cost of the path as a value that depends on a data amount per unit time of the data to be used by the target service on the path. In this manner, it is possible to calculate an appropriate cost by calculating the total cost in consideration of the basis cost that depends on the data amount per unit time.

Furthermore, in this embodiment, the arrangement measurement unit 512 identifies a candidate course with the minimum total cost among candidate courses of the target service for which available resources of computers on the candidate courses cover a resource required for a transfer service required when the candidate courses are used in the target service. Execution of the transfer service on the computers on the course is considered, and a candidate course with the minimum total cost, which can execute the transfer service, is identified, and thus it is possible to propose a destination in which the target service is to be deployed, capable of executing the transfer service.

Furthermore, in this embodiment, the service information acquisition unit 511 receives specification of the target sensor, the required resource, and the target controller, which is input by a user, for the target service. In this manner, the user can specify the sensor, the resource, and the controller to enable calculation of the total cost of deployment of the desired target service.

Furthermore, in this embodiment, the result output unit 513 that presents, to a user, the total cost and the candidate computer for at least one candidate course is further included. With this configuration, the user can receive, for the target service, proposition of a candidate computer in which the processing of the service is to be deployed, and a total cost in that case.

### Second Embodiment

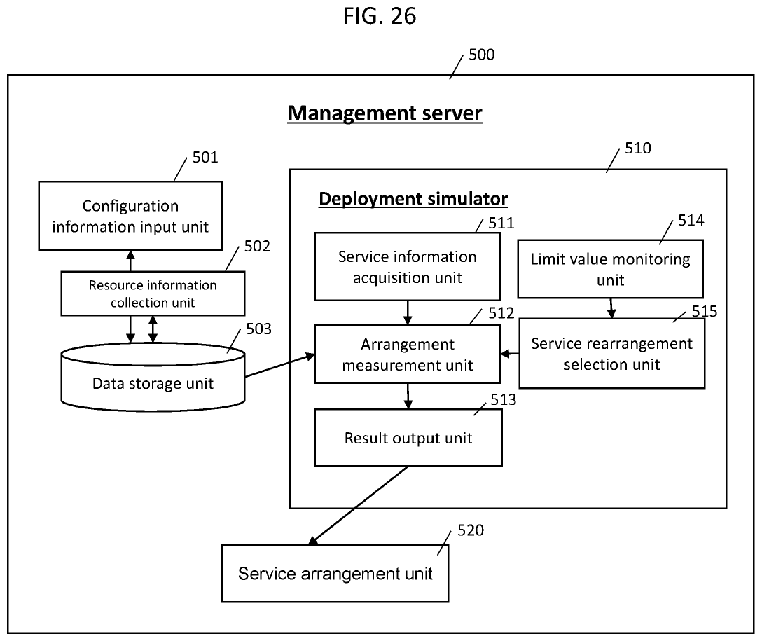

FIG. 26 is a diagram illustrating an exemplary configuration of a management sever according to a second embodiment.

The management server 500 according to the second embodiment further includes a limit value monitoring unit 514 and a service rearrangement selection unit 515 in addition to the configuration of the management server 500 according to the first embodiment illustrated in FIG. 2.

The limit value monitoring unit 514 extracts, from among the edge computers 10 included in the computing system, a computer for which the used resource exceeds a predetermined threshold value as a critical computer.

The service rearrangement selection unit 515 selects, from computing services deployed in the critical computer, one or more services based on a priority set in advance for the resource or service required for the service, and sets the selected services as the target service. The selected target service is deployed in the computing system again similarly to the service acquired by the service information acquisition unit 511. That is, the target service is deleted from the edge computer 10 in which the target service is currently deployed, and is deployed in another suitable edge computer 10.

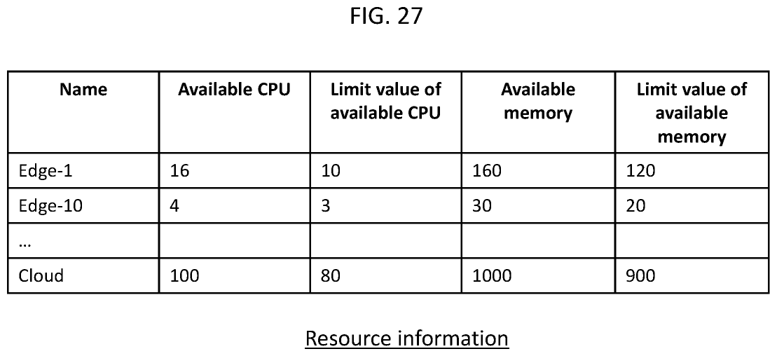

FIG. 27 is a diagram illustrating an exemplary configuration of resource information according to the second embodiment. The resource information illustrated in FIG. 27 includes, as parameters, a limit value of the available CPU and a limit value of the available memory in addition to the parameters included in the resource information illustrated in FIG. 6. The limit value of the available CPU and the limit value of the available memory are threshold values for determining a critical computer. In this case, when the amount of available resources of a CPU of the edge computer 10 exceeds the limit value of the available CPU, and the amount of available resources of a memory exceeds the limit value of the available memory, that edge computer 10 is determined to be a critical computer.

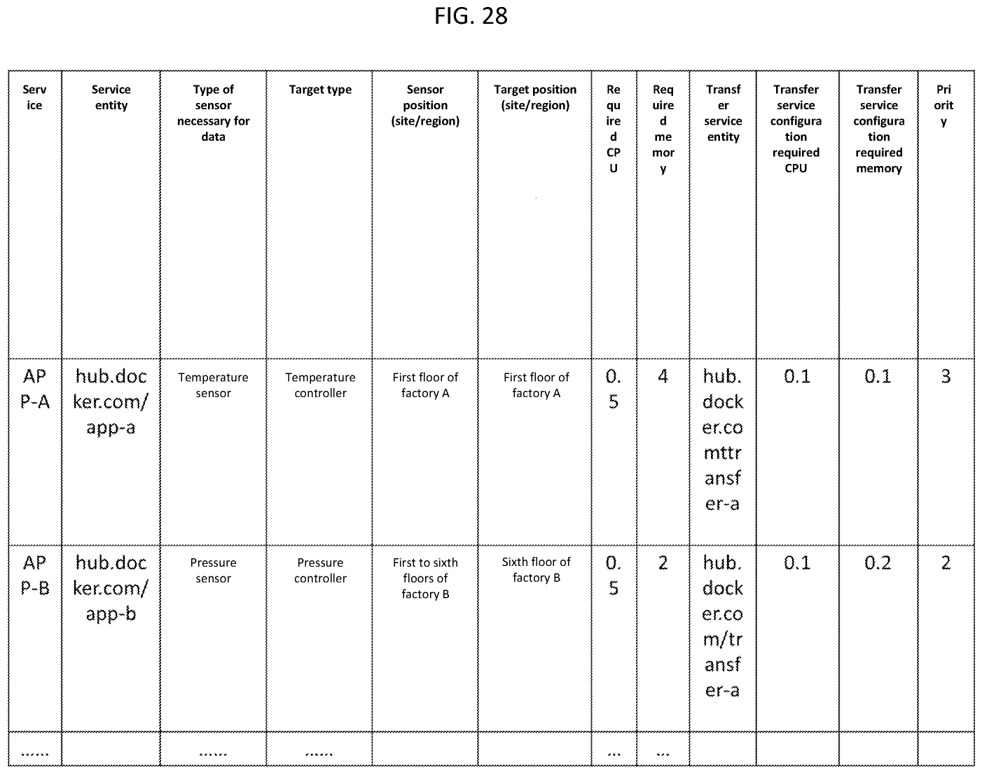

FIG. 28 is a diagram illustrating an exemplary configuration of service information according to the second embodiment. The service information illustrated in FIG. 28 includes, as a parameter, a priority in addition to the parameters included in the service information illustrated in FIG. 5. The priority is a relative indicator for determining which computing service is to be treated preferentially as an example. It is assumed that a larger value indicates a higher priority. A computing service with a lower priority, namely, a computing service with a lower value of the priority is selected to be deployed again. The priority is set in advance.

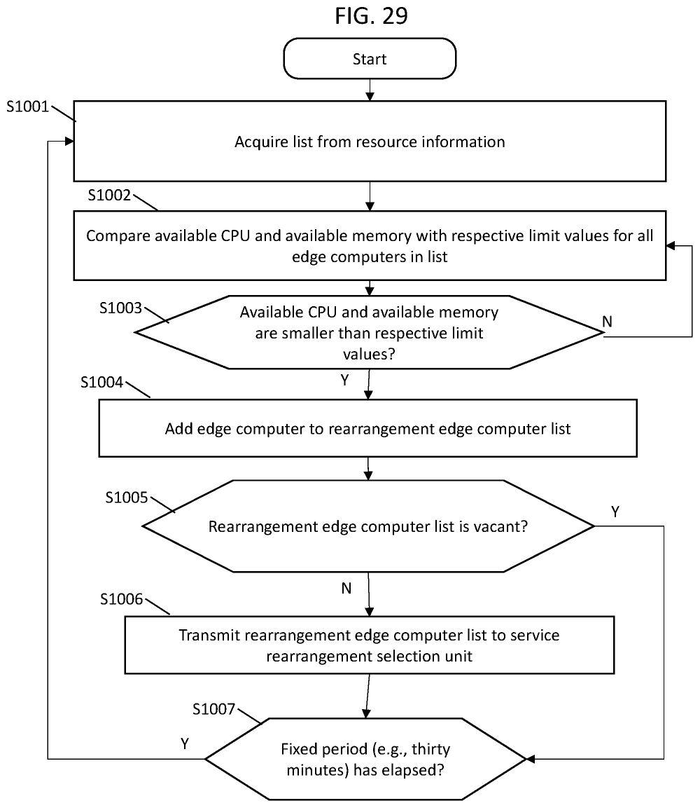

FIG. 29 is a flow chart illustrating an example of processing by the limit value monitoring unit.

The limit value monitoring unit 514 acquires a list of parameters “name” from the resource information stored in the data storage unit 503 (S1001). As a result, a list of computers in which the computing service can be deployed, including the edge computer 10 and the cloud 100, is acquired.

Next, the limit value monitoring unit 514 selects one edge computer 10 from among the plurality of edge computers 10 included in the list, and compares the available CPU and the available memory of the selected edge computer 10 with respective limit values (S1002). The limit value monitoring unit determines whether the available CPU and the available memory of the edge computer 10 selected in S1002 are smaller than the respective limit values (S1003).

When the available CPU and the available memory of the edge computer 10 selected in S1002 are equal to or larger than the respective limit values (S1003: NO), the limit value monitoring unit 514 returns to the processing of S1002, and selects another edge computer 10.

On the other hand, when the available CPU and the available memory of the edge computer 10 selected in S1002 are smaller than the respective limit values (S1003: YES), the limit value monitoring unit proceeds to the next processing of S1004. The limit value monitoring unit determines the selected edge computer 10 to be a critical computer, and adds the selected edge computer 10 to a rearrangement edge computer list (S1004).

Next, the limit value monitoring unit 514 determines whether the rearrangement edge computer list is vacant (S1005). When the rearrangement edge computer list is vacant (S1005: YES), the limit value monitoring unit proceeds to the processing of S1007. On the other hand, when the rearrangement edge computer list is not vacant (S1005: NO), the limit value monitoring unit 514 transmits the rearrangement edge computer list to the service rearrangement selection unit 515 (S1006).

Then, the limit value monitoring unit 514 waits until a predetermined period of time (e.g., 30 minutes) has elapsed (S1007: NO), and after a predetermined period of time has elapsed (S1007: YES), the limit value monitoring unit 514 returns to the processing of S1001.

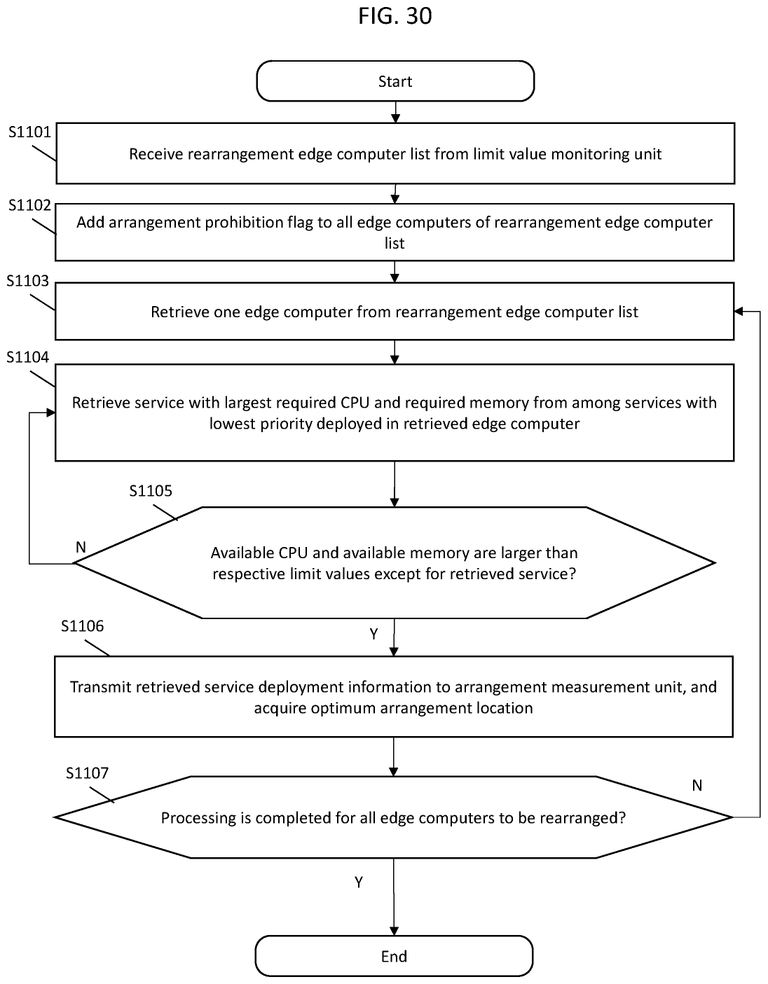

FIG. 30 is a flow chart illustrating an example of processing by the service rearrangement selection unit.

The service rearrangement selection unit 515 receives the rearrangement edge computer list from the limit value monitoring unit (S1101). The service rearrangement selection unit 515 adds an arrangement prohibition flag to all the edge computers 10 of the rearrangement edge computer list (S1102). The arrangement prohibition flag is a flag for prohibiting the computing service from being deployed again.

The service rearrangement selection unit 515 selects one edge computer 10 from the rearrangement edge computer list (S1103). The service rearrangement selection unit 515 selects services with the lowest priority from among computing services deployed in the edge computer 10 selected in S1103, and retrieves a service with the largest required CPU and required memory from among the selected services (S1104). When a service with the largest required CPU and a service with the largest required memory are different from each other, any one of the services may be selected and retrieved.

The service rearrangement selection unit 515 determines whether a sum of the available CPU and the required CPU of the service retrieved in S1104 is larger than the limit value of the available CPU and a sum of the available memory and the required memory of the service retrieved in S1104 is larger than the limit value of the available memory (S1105).

When the sum of the available CPU and the required CPU of the service retrieved in S1104 is equal to or larger than the limit value of the available CPU, or the sum of the available memory and the required memory of the service retrieved in S1104 is equal to or larger than the limit value of the available memory (S1105: NO), the service rearrangement selection unit 515 returns to the processing of S1104, and retrieves another service.

On the other hand, when the sum of the available CPU and the required CPU of the service retrieved in S1104 is larger than the limit value of the available CPU, and the sum of the available memory and the required memory of the service retrieved in S1104 is larger than the limit value of the available memory (S1105: YES), the service rearrangement selection unit 515 proceeds to the next processing of S1106.

The service rearrangement selection unit 515 transmits the retrieved service information to the arrangement measurement unit 512, and calculates an optimum arrangement location (S1106). Then, the service rearrangement selection unit 515 determines whether selection is complete for all the edge computers 10 of the rearrangement edge computer list (S1107). When the rearrangement edge computer list includes an unselected edge computer (S1107: NO), the service rearrangement selection unit 515 returns to the processing of S1103, and selects one unselected edge computer 10. When selection is complete for all the edge computers of the rearrangement edge computer list (S1107: YES), the service rearrangement selection unit 515 finishes the processing.

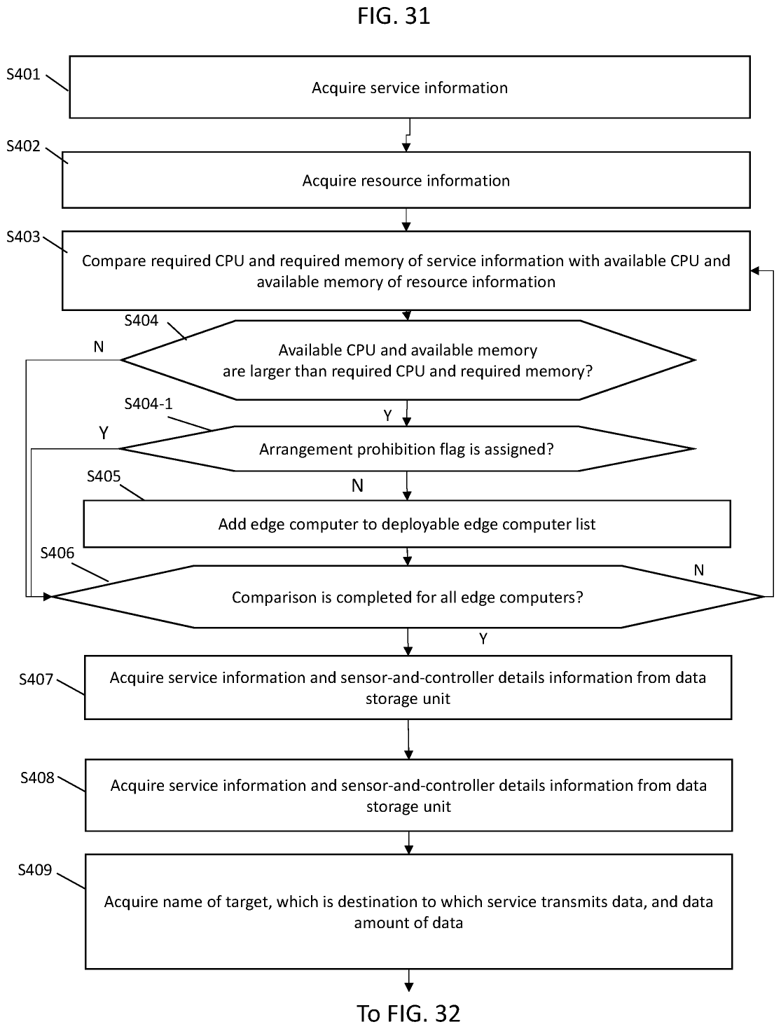

FIG. 31 is a flow chart illustrating an example of processing by the arrangement measurement unit according to the second embodiment. The flow chart illustrated in FIG. 31 is different from the flow chart illustrated in FIG. 18 in that the next processing is executed when the determination of S404 in the flow chart illustrated in FIG. 18 results in YES.

Specifically, when the determination of S404 results in YES, the arrangement measurement unit 512 determines whether an arrangement prohibition flag is assigned to the selected edge computer 10 (S404-1).

When an arrangement prohibition flag is assigned to the selected edge computer 10 (S404-1: YES), the arrangement measurement unit 512 proceeds to the processing of S406, whereas when an arrangement prohibition flag is not assigned to the selected edge computer 10 (S404-1: NO), the arrangement measurement unit 512 proceeds to the processing of S405. Other processing is similar to that of FIG. 18, and thus description thereof is omitted here.

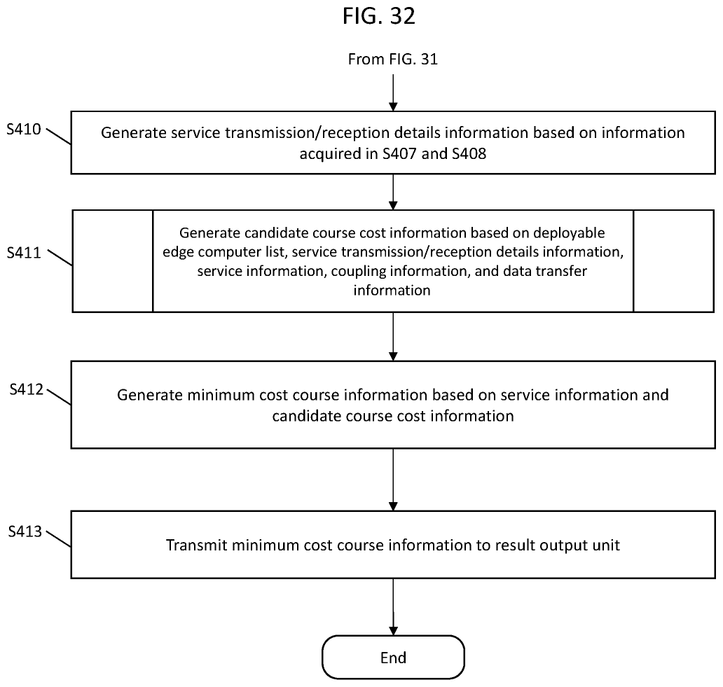

FIG. 32 is a flow chart illustrating continuation of the processing of FIG. 31. The processing illustrated in FIG. 32 is similar to the processing illustrated in FIG. 19, and thus description thereof is omitted here.

According to this embodiment, a computer for which a used resource exceeds a predetermined threshold value is extracted as a critical computer from among the computers included in the computing system, and one or more services are selected from among services deployed in the critical computer based on a priority set in advance for resources required for the services or set in advance for the services, and are set as the target service. A service deployed in a computer having a large resource usage load is deployed again, and thus it is possible to deploy the service of the computing system again and ease concentration of the load when any one of the computers has a larger resource load.

### Third Embodiment

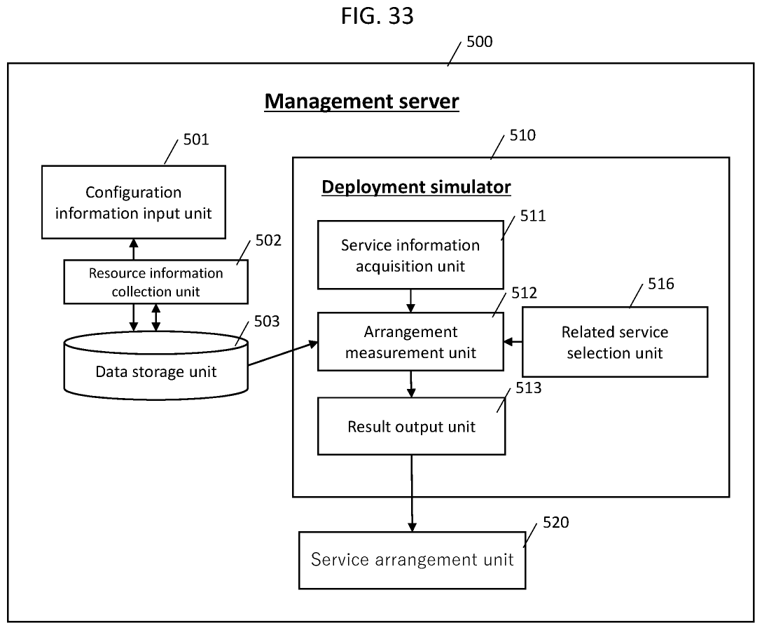

FIG. 33 is a diagram illustrating an exemplary configuration of a management sever according to a third embodiment.

In addition to the configuration included in the management server 500 according to the first embodiment illustrated in FIG. 2, the management server 500 illustrated in FIG. 33 includes a related service selection unit 516.

The related service selection unit 516 selects, from among computing service deployed in the computing system, a computing service that uses the sensor 50, the controller 60, or a computer, to which some change has been made, and sets the computing service as the target service. Similarly to the service acquired in the service information acquisition unit 511, the selected target service is appropriately deployed in the computing system again. In other words, the target service is deleted from the edge computer 10 in which the target service is currently deployed, and is deployed in another suitable edge computer 10.

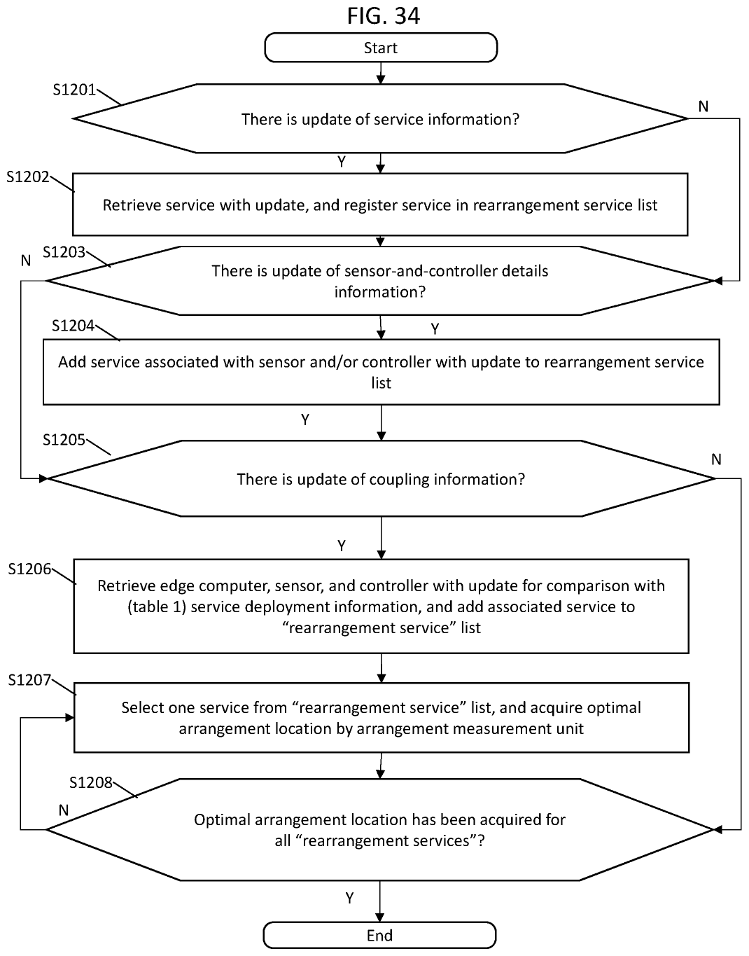

FIG. 34 is a flow chart illustrating an example of processing by the related service selection unit.

The related service selection unit 516 determines whether there is an update of the service information (S1201). When there is no update of the service information (S1201: NO), the related service selection unit 516 proceeds to the processing of S1203. On the other hand, when there is an update of the service information (S1201: YES), the related service selection unit 516 retrieves a service with an update, and registers the service in the rearrangement service list (S1202). Then, the related service selection unit 516 proceeds to the processing of S1203.

Next, the related service selection unit 516 determines whether there is an update of the sensor-and-controller details information (S1203). When there is no update of the sensor-and-controller details information (S1203: NO), the related service selection unit 516 proceeds to the processing of S1205. On the other hand, when there is an update of the sensor-and-controller details information (S1203: YES), the related service selection unit 516 retrieves information on the sensor 50 and/or the controller 60 with an update, compares the information with the service information, extracts a computing service associated with the sensor 50 and/or the controller 60 with an update, and adds the computing service to the rearrangement service list (S1204). Then, the related service selection unit 516 proceeds to the processing of S1205. The computing service associated with the sensor 50 and/or the controller 60 with an update means a computing service that uses the sensor 50 and/or the controller 60.

Next, the related service selection unit 516 determines whether there is an update of the coupling information (S1205). When there is no update of the coupling information (S1205: NO), the related service selection unit 516 proceeds to the processing of S1208. On the other hand, when there is an update of the coupling information (S1205: YES), the related service selection unit 516 proceeds to the processing of S1206.

The related service selection unit 516 retrieves a piece of equipment with an update in the coupling information, compares the piece of equipment with the service information, and adds a computing service associated with the piece of equipment to the rearrangement service list (S1206). The computing service associated with the piece of equipment means a computing service that uses the piece of equipment.

Next, the related service selection unit 516 selects one service from the rearrangement service list, and the arrangement measurement unit 512 calculates an optimal arrangement location of the service (S1207). Then, the related service selection unit 516 determines whether all the services have been selected from the rearrangement service list (S1208).

When an unselected service remains (S1208: NO), the related service selection unit 516 returns to the processing of S1207, and selects one unselected service. When all the services have been selected (S1208: YES), the related service selection unit 516 finishes the processing.

According to this embodiment, the related service selection unit 516 selects, from among services deployed in the computing system, a service that uses the sensor 50, the controller, or a computer, to which some change has been made, and sets the selected service as the target service. A service associated with the sensor 50, the controller, or a computer, to which a change has been made, is set as the target service for calculation of redeployment in the computing system, and thus it is possible to suitably deploy the service of a computing system in a new state again when some change has been made.

The above-mentioned embodiments of the present invention are examples for describing the present invention, and the scope of the present invention is not intended to be limited to those embodiments. A person skilled in the art can implement the present invention in other various modes without departing from the scope of the present invention.

What is claimed is:

1. A computing service management apparatus configured to support deployment of a service, the service executing control by a controller based on the data acquired by a sensor, in a computing system including computers each having a resource available for processing of analyzing data acquired from a sensor and generating an instruction signal instructing the controller to execute control in the service, the computing service management apparatus comprising:
a resource information collection unit configured to acquire resource information indicating an available resource that is available among resources included in the computers;
a service information acquisition unit configured to acquire, for a target service to be deployed in the computing system, service information including a type of a target sensor configured to acquire data to be used by the target service, a required resource required for the target service, and a type of a target controller configured to execute control by the target service; and
an arrangement measurement unit configured to acquire data transfer information indicating a course through which data used by a co-existing service co-existing with the target service in the computing system flows, set a computer that covers the required resource by the available resource as a candidate computer, extract a candidate course which is a combination of an input course from the target sensor to the candidate computer and an output course from the candidate computer to the target controller, and calculate, for the candidate course and at least the input course, a total cost for causing data to be used by the target service to flow, by considering using data caused to flow by the co-existing service for the target service for a path through which the data to be used by the target service is caused to flow by the co-existing service.

2. The computing service management apparatus according to claim 1, wherein
the arrangement measurement unit is configured to
determine, for each path included in the input course, whether the data to be used by the target service is caused to flow through the path by the co-existing service, set a cost increase amount as zero for a path through which the data to be used by the target service is caused to flow by the co-existing service, set the cost increase amount as a value that depends on a data amount per unit time of the data to be used by the target service for a path through which the data is not caused to flow by the co-existing service, set a cost of the path as a sum of a basic cost of the path and the cost increase amount, and
calculate a total cost of the candidate course based on a total sum of costs of a path included in the input course and a path included in the output course.

3. The computing service management apparatus according to claim 2, wherein
the arrangement measurement unit is configured to set the basic cost of the path as a value that depends on a data amount per unit time of the data to be used by the target service on the path.

4. The computing service management apparatus according to claim 2, wherein
the arrangement measurement unit is configured to identify a candidate course with a minimum total cost among candidate courses of the target service for which available resources of computers on the candidate courses cover a resource required for a transfer service required when the candidate courses are used in the target service.

5. The computing service management apparatus according to claim 1, wherein
the service information acquisition unit is configured to receive specification of the target sensor, the required resource, and the target controller, the specification being input by a user, for the target service.

6. The computing service management apparatus according to claim 1, further comprising
a result output unit configured to present, to a user, the total cost and the candidate computer for at least one candidate course.

7. The computing service management apparatus according to claim 1, further comprising:
a limit value monitoring unit configured to extract, from among the computers included in the computing system, a computer for which a used resource exceeds a predetermined threshold value as a critical computer; and
a service redeployment selection unit configured to select, from among services deployed in the critical computer, one or more services based on a priority set in advance for resources required for the services or set in advance for the services, and set the selected services as the target service.

8. The computing service management apparatus according to claim 1, further comprising a related service selection unit configured to select, from among services deployed in the computing system, a service that uses a sensor, a controller, or a computer, to which a change has been made, and set the selected service as the target service.

9. A computing service management method for supporting deployment of a service, the service executing control by a controller based on the data acquired by a sensor, in a computing system including computers which are capable of being coupled to both or one of a sensor and the controller and each of which has a resource available for processing of analyzing data and generating a control instruction signal in the service, the computing service management method comprising:
acquiring resource information indicating an available resource that is available among resources included in the computers;
acquiring, for a target service to be deployed in the computing system, service information including a target sensor that acquires data to be used by the target service, a required resource required for the target service, and a target controller that executes control by the target service; and
acquiring data transfer information indicating a course through which data used by a co-existing service co-existing with the target service in the computing system flows, setting a computer that covers the required resource by the available resource as a candidate computer, extracting a candidate course which is a combination of an input course from the target sensor to the candidate computer and an output course from the candidate computer to the target controller, and calculating, for the candidate course and at least the input course, a total cost for causing data to be used by the target service to flow, by considering using data caused to flow by the co-existing service for the target service for a path through which the data to be used by the target service is caused to flow by the co-existing service.

10. An information processing apparatus-readable storage medium having stored thereon a computing service management program for causing the information processing apparatus to execute processing of supporting deployment of a service, the service executing control by a controller based on the data acquired by a sensor, in a computing system including computers each having a resource available for processing of analyzing data and generating a control instruction signal, which are capable of being coupled to both or one of a sensor and a controller, in the service, the computing service management program causing the information processing apparatus to:
acquire resource information indicating an available resource that is available among resources included in the computers;
acquire, for a target service to be deployed in the computing system, service information including a target sensor configured to acquire data to be used by the target service, a required resource required for the target service, and a target controller configured to execute control by the target service;
acquire data transfer information indicating a course through which data used by a co-existing service co-existing with the target service in the computing system flows, set a computer configured to cover the required resource by the available resource as a candidate computer, extract a candidate course which is a combination of an input course from the target sensor to the candidate computer and an output course from the candidate computer to the target controller, and calculate, for the candidate course and at least the input course, a total cost for causing data to be used by the target service to flow, by considering using data caused to flow by the co-existing service for the target service for a path through which the data to be used by the target service is caused to flow by the co-existing service.
